(19) United States
(12) Patent Application Publication
(10) Pub. No.: US 2022/0212178 A1
(43) Pub. Date: Jul. 7, 2022

(54) METAL OXIDE NANOPARTICLES BASED CATALYST AND METHOD OF MANUFACTURING AND USING THE SAME

(71) Applicant: BASF Corporation, Florham Park, NJ (US)

(72) Inventors: Fudong LIU, Orlando, FL (US); Michel DEEBA, East Brunswick, NJ (US); Ke-Bin LOW, Iselin, NJ (US); Haiyang ZHU, Iselin, NJ (US)

(21) Appl. No.: 17/594,775

(22) PCT Filed: Apr. 28, 2020
(86) PCT No.: PCT/US2020/030199

§ 371 Date: Oct. 29, 2021

Related U.S. Application Data
(60) Provisional application No. 62/840,428, filed on Apr. 30, 2019.

(30) Foreign Application Priority Data
May 31, 2019 (EP) 19177598.0

(51) Int. Cl. B01J 35/00; B01J 35/10; B01J 23/44; B01J 21/04; B01J 35/02; B01J 23/46; B01J 37/08; B01J 23/10; B01J 37/03; B01J 37/04; B01J 21/06; B01J 23/02; B01D 53/94; F01N 3/28

(52) U.S. Cl. CPC B01J 35/0006; F01N 3/101; B01J 35/1038; B01J 23/44; B01J 21/04; B01J 35/023; B01J 23/464; B01J 37/082; B01J 23/10; B01J 37/038; B01J 37/04; B01J 21/066; B01J 23/02; B01D 53/945; F01N 3/2825; F01N 3/2842; B01D 2255/1023; B01D 2255/20715; B01D 2255/1021; B01D 2255/9155; B01D 2255/1025; B01D 2255/2092; B01D 2255/908; B01D 2255/2042; B01D 2255/2063; B01D 2255/2065; B01D 2255/9022; F01N 2370/02; B01J 35/1014

(57) ABSTRACT

The presently claimed invention provides an automotive catalyst comprising a platinum group metal selected from palladium, platinum, rhodium and any combination thereof; metal oxide nanoparticles; and a carrier, wherein the platinum group metal and the metal oxide nanoparticles are homogeneously dispersed on the carrier such as alumina component. The metal oxide nanoparticles have a D₉₀ diameter in the range of 1.0 nm to 50 nm. The presently claimed invention also provides a layered catalytic article comprising catalyst comprising at least one platinum group metal; metal oxide nanoparticles; and a carrier. The presently claimed invention also provides a process for preparing the catalyst and the catalytic article, and a method of treating a gaseous exhaust stream comprising contacting the stream with the catalyst or catalytic article.

### CROSS-REFERENCE TO RELATED APPLICATIONS

This application claims the benefit of priority to U.S. Provisional Application No. 62/840,428, filed on Apr. 30, 2019, and to European Application No. 19177598.0, filed on May 31, 2019 in their entirety.

### FIELD OF THE INVENTION

The presently claimed invention relates to an automotive catalyst and a layered catalytic article that is useful for the treatment of exhaust gases to reduce pollutants contained therein.

Particularly, the presently claimed invention relates to the automotive catalyst and the layered catalytic article comprising a platinum group metal such as platinum, palladium, rhodium, or their combination deposited with a colloidal metal oxide component on a stabilized support such as alumina.

### BACKGROUND OF THE INVENTION

The pollutants such as hydrocarbons (HC), carbon monoxide (CO), and nitrogen oxides (NOx) that are present in the exhaust gases are typically reduced using catalyst compositions or catalytic articles positioned in the gas exhaust system in order to meet strict government regulations. The catalyst compositions or articles are made from platinum group metals (PGM) such as platinum, palladium, and rhodium. The platinum group metal-based catalysts such as three-way conversion (TWC) catalysts or four-way conversion (FWC) catalysts are well known to reduce the pollutants from a gasoline engine effectively. However, as the platinum group metals are expensive, there is a demand for providing TWC or FWC catalysts and systems with a reduced amount of PGM.

In order to meet such a demand, various attempts have been made in the past which include at least partially replacing PGM with other metals such as base metals which are much cheaper and are available in large quantities. However, these catalysts and systems suffer from one or more drawbacks which include, but are not limited to, a lack of desired efficiency of oxidizing HC and CO and reducing NOx, a low thermal stability and the like. Thus, these catalysts still utilize a high amount of PGM to achieve the desired efficiency, which renders them unable to reduce the overall cost.

Further, it is also found that in some catalysts or systems, the addition of base metals to the catalysts resulted in poisoning of PGM and led to decreased catalytic efficiency.

Thus, it is desired to provide another approach which is different from the known approach of partially replacing the PGM with non-PGM. Accordingly, the presently claimed invention is directed to improving the platinum group metal (PGM) effectiveness in three-way conversion (TWC) catalysts or four-way conversion (FWC) catalysts applied for gasoline emission control, which in-turn can reduce the utilization of costlier platinum group metal such as palladium.

### SUMMARY OF THE INVENTION

In a first aspect, the presently claimed invention provides an automotive catalyst comprising a platinum group metal selected from palladium, platinum, rhodium and any combination thereof in an amount of 1.0 to 10 wt. %, based on the total weight of the catalyst, metal oxide nanoparticles in an amount of 1.0 to 20 wt. %, based on the total weight of the catalyst, and an alumina component, wherein the platinum group metal and the metal oxide nanoparticles are homogeneously dispersed on the alumina component determined by Transmission Electron Microscopy (TEM) analysis or Energy-Dispersive x-ray Spectroscopy (EDS) analysis, wherein the weight ratio of the metal oxide nanoparticles to the alumina component is in the range of 1:1.5 to 1:10.

In one or more embodiments, the metal oxide nanoparticles have a D₉₀ diameter in the range of 1.0 nm to 50 nm, measured by Transmission Electron Microscopy (TEM), and the platinum group metal(s) is in intimate contact with the metal oxide nanoparticles. The metal oxide nanoparticles include, but are not limited to, zirconia nanoparticles, ceria nanoparticles, manganese oxide, alumina nanoparticles, and titania nanoparticles.

The presently claimed invention also provides a process for the preparation of an automotive catalyst which involves i) dispersing at least one platinum group metal selected from palladium, platinum and rhodium into colloidal metal oxide nanoparticles having a D₉₀ diameter in the range of 1.0 nm to 50 nm to obtain a mixture; and ii) co-impregnating said mixture on a carrier to obtain a catalyst.

In another aspect, a layered automotive catalytic article comprising the catalyst of the presently claimed invention deposited on a substrate is provided.

In one embodiment, the catalytic article comprises a bottom layer and a top layer, wherein the bottom layer comprises catalyst of the presently claimed invention, the top layer comprises at least one platinum group metal, and at least one support; and a substrate

In another embodiment, the bottom layer comprises at least one platinum group metal, and at least one support, the top layer comprises catalyst of the presently claimed invention.

In another embodiment, both the top layer and the bottom layer comprise i) rhodium supported on a support, and ii) catalyst of the presently claimed invention.

In still another aspect, the presently claimed invention provides a process for the preparation of the layered catalytic article.

In yet another aspect, the presently claimed invention provides a method of treating a gaseous exhaust stream which involves contacting the exhaust stream with the catalyst or a layered catalytic article according to the presently claimed invention.

In a further aspect, the presently claimed invention provides a use of the catalyst or the layered catalytic article of the presently claimed invention for purifying a gaseous exhaust stream.

In still a further aspect, the presently claimed invention provides an exhaust system for internal combustion engines comprising the catalyst or catalytic article disposed downstream from an internal combustion engine.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings.

FIG. 1A is a schematic representation of catalytic article design (IC-1) in an exemplary layered configuration according to one embodiment of the invention.

FIG. 1B is a schematic representation of catalytic article design (IC-2) in an exemplary layered configuration according to another embodiment of the invention.

FIG. 1C is a schematic representation of catalytic article design (IC-3) in exemplary layered configuration according to other embodiment of the invention.

FIG. 1D is a schematic representation of catalytic article designs (IC-5 & IC-6) in exemplary layered configurations according to other embodiments of the invention.

FIG. 2A is a schematic representation of FTP-75 test results on a vehicle for the reference catalyst (RC-1) and the catalyst (IC-1) according to one embodiment of the presently claimed invention for cumulative mid-bed and tail-pipe HC and NOx emission.

FIG. 2B is a schematic representation of FTP-75 test results on a vehicle for the reference catalyst (RC-2) and the catalyst (IC-2) according to another embodiment of the presently claimed invention for cumulative mid-bed and tail-pipe HC and NOx emission.

FIG. 2C is a schematic representation of FTP-75 test results on a vehicle for the reference catalyst (RC-3) and the catalyst (IC-3) according to still another embodiment of the presently claimed invention for cumulative mid-bed and tail-pipe HC and NOx emission.

FIG. 3A is a perspective view of a honeycomb-type substrate carrier which may comprises the layered catalyst composition in accordance with one embodiment of the presently claimed invention.

FIG. 3B is a partial cross-section view enlarged relative to FIG. 3A and taken along a plane parallel to the end faces of the substrate carrier of FIG. 3A, which shows an enlarged view of a plurality of the gas flow passages shown in FIG. 3A.

FIG. 4 is a cutaway view of a section enlarged relative to FIG. 3A, wherein the honeycomb-type substrate in FIG. 3A represents a wall flow filter substrate monolith.

FIG. 5 shows comparative transmission electron microscopic (TEM) analysis of an automotive catalyst prepared according to the invention and conventionally prepared catalyst.

FIG. 6 shows comparative Energy-Dispersive x-ray Spectroscopic (EDS) analysis of an automotive catalyst that are prepared according to the invention and conventionally prepared catalyst.

### DETAILED DESCRIPTION

The presently claimed invention now will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

As used herein, the term “catalyst” or “catalyst composition” refers to a material that promotes a reaction.

As used herein, the term “stream” broadly refers to any combination of flowing gas that may contain solid or liquid particulate matter.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The terms “exhaust stream”, “engine exhaust stream”, “exhaust gas stream”, and the like refer to any combination of flowing engine effluent gas that may also contain solid or liquid particulate matter. The stream comprises gaseous components and is, for example, exhaust of a lean burn engine, which may contain certain non-gaseous components such as liquid droplets, solid particulates and the like. An exhaust stream of a lean burn engine typically further comprises combustion products, products of incomplete combustion, oxides of nitrogen, combustible and/or carbonaceous particulate matter (soot) and un-reacted oxygen and/or nitrogen. Such terms refer as well as to the effluent downstream of one or more other catalyst system components as described herein.

The presently claimed invention is focused on improving the platinum group metal (PGM) effectiveness in the catalysts such as three-way conversion (TWC) catalysts and four-way conversion (FWC) catalysts which are used for gasoline, diesel, compressed natural gas and liquified petroleum gas emission control. In the presently known TWC technologies, the heavily used PGM is palladium, which is very important for HC oxidation and NOx reduction.

In one embodiment, improving the effectiveness of palladium (Pd) is targeted as palladium is typically used in a much larger quantity than rhodium (Rh). The presently claimed invention provides an effective way of using colloidal metal oxide including, but not limited to, colloidal ZrO₂ as an efficient Pd promoter to prepare highly robust TWC or FWC catalysts.

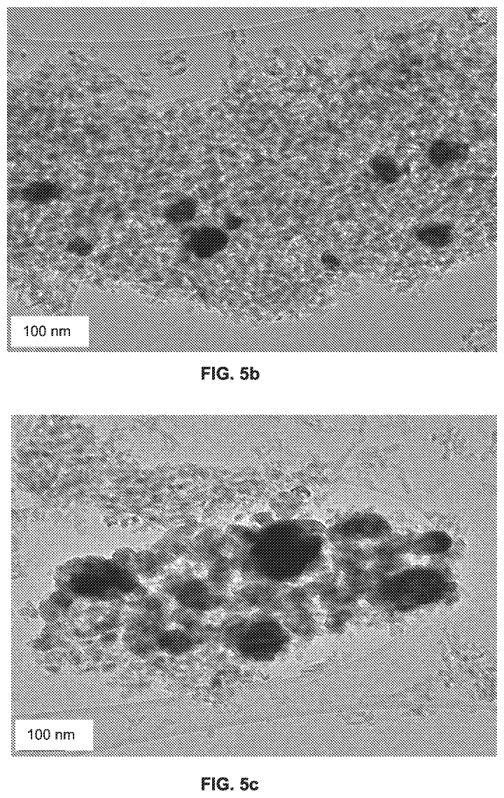

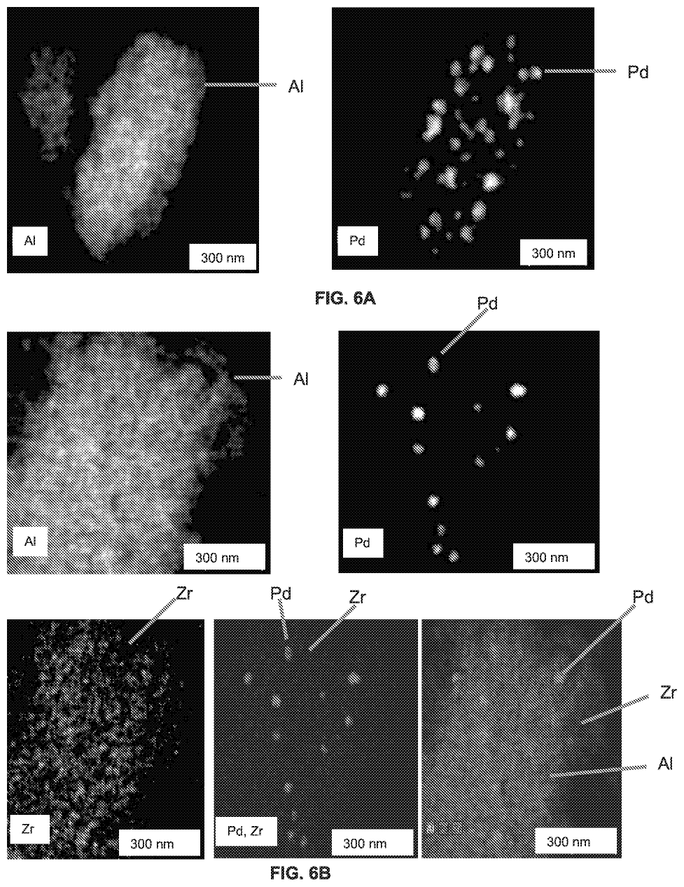

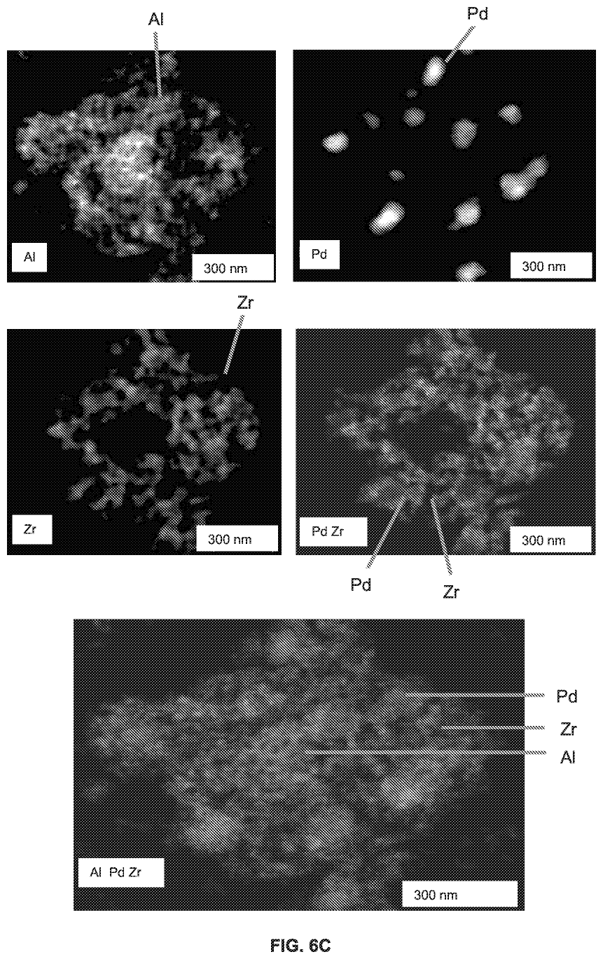

In one embodiment, the presently claimed invention provides an automotive catalyst comprising a platinum group metal selected from palladium, platinum, rhodium and any combination thereof in an amount of 1.0 to 10 wt. %, based on the total weight of the catalyst, metal oxide nanoparticles in an amount of 1.0 to 20 wt. %, based on the total weight of the catalyst, and an alumina component as a carrier, wherein the weight ratio of the metal oxide nanoparticles to the alumina component is in the range of 1:1.5 to 1:10, wherein the platinum group metal and the metal oxide nanoparticles are homogeneously dispersed on the alumina component. The term ‘homogeneously dispersed’ refers to uniform distribution or dispersion of each component throughout or within a matrix. i.e. any given surface area has the substantially similar loading of nanoparticles and PGM, respectively, and is devoid of aggregates of PGM and nanoparticles larger than 100 nm. The substantially similar loading means the variation is no greater than 25%, preferably no greater than 10%. In one embodiment, the homogenous dispersion of components of catalyst is determined by Transmission Electron Microscopy (TEM) analysis and is shown in FIG. 5. In another embodiment, the homogenous dispersion of components of catalyst is determined by Energy-Dispersive x-ray Spectroscopy (EDS) analysis and is shown in FIG. 6. The metal oxide nanoparticles include, but are not limited to, zirconia nanoparticles, ceria nanoparticles, alumina nanoparticles, and titania nanoparticles. The metal oxide nanoparticles have a D₉₀ diameter in the range of 1.0 nm to 50 nm. In one exemplary embodiment, the metal oxide nanoparticles have a D₉₀ diameter in the range of 5.0 nm to 20 nm.

D₉₀ diameter is expressed as a value wherein at least 90% of the particles have pre-determined particle size (diameter). In other words, only 10% of the particles will have a particle size that is larger than the D₉₀. The particle size is measured by Transmission Electron Microscopy (TEM). In one embodiment, Bright-Field TEM images of nanoparticles can be collected using a charge-coupled device (CCD) camera and the diameters of individual particles can be measured manually using the image acquisition software's ‘line-measurement’ tool. In one embodiment, the particle size is measured by a light scattering method. In one preferred embodiment, the platinum group metal is palladium In one of the exemplary embodiments, the amount of metal oxide nanoparticles is in the range of 3.0 to 15 wt. %, based on the total weight of the catalyst. Typically, the weight is calculated as a dry weight (post calcination) of catalyst or wash coat.

In accordance with the presently claimed invention the platinum group metal(s) is in intimate contact with the metal oxide nanoparticles. Reference to “intimate contact” includes having an effective amount of components in such contact (for example, Pd and zirconia) on the same support, in direct contact, and/or in substantial proximity such that the zirconia contacts alumina before the Pd component. The intimate contact of PGM with the metal oxide nanoparticles is determined by Transmission Electron Microscopy (TEM) or scanning electron microscopy (SEM).

A platinum group metal (PGM) component refers to any component that includes a PGM (Ru, Rh, Ir, Pd, Pt and/or Au). For example, the PGM may be in metallic form, with zero valence, or the PGM may be in an oxide form. Reference to “PGM component” allows for the presence of the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide.

In one embodiment, the metal oxide nanoparticles comprise a dopant selected from lanthana, barium, manganese, yttrium, praseodymium, neodymium, ceria and strontium. The amount of dopant is in the range from 1.0 to 30 wt. %, based on the total weight of the metal oxide.

The term dopant in the context of the presently claimed invention refers to a promoter or a stabilizer. For instance, lanthana and baria can act as a stabilizer, whereas manganese, yttrium, praseodymium, neodymium and cerium can act as a promoter.

In one of the embodiments, the metal oxide nanoparticles are selected from zirconia nanoparticles, lanthana-zirconia nanoparticles, barium-zirconia nanoparticles, yitria-zirconia nanoparticles, ceria-zirconia nanoparticles, alumina nanoparticles, ceria nanoparticles, and manganese oxide nanoparticle. In another embodiment, the metal oxide nanoparticles are selected from lanthana-alumina nanoparticles, ceria-alumina nanoparticles, ceria-zirconia-alumina nanoparticles, zirconia-alumina nanoparticles, lanthana-zirconia-alumina nanoparticles, baria-alumina nanoparticles, baria-lanthana-alumina nanoparticles, baria-lanthana-neodymia-alumina nanoparticles, baria-ceria-alumina nanoparticles, and ceria-zirconia-alumina nanoparticles. In still another embodiment, the metal oxide nanoparticles are manganese-ceria nanoparticles.

In one embodiment, the alumina component is an alumina. In another embodiment, the alumina component is an alumina doped with a dopant, wherein the dopant is selected from lanthana, ceria, ceria-zirconia, zirconia, lanthana-zirconia, baria, baria-lanthana, baria-lanthana-neodymia, baria-ceria, ceria-zirconia and any combination thereof. The amount of the dopant is in the range from 5.0 to 30 wt. %, based on the total weight of alumina. In one illustrative embodiment, the alumina component is an alumina or alumina doped with a dopant, with a surface area of >20 m²/g and average pore volume greater than 0.2 cc/g.

In one embodiment, the catalyst of the presently claimed invention comprises a platinum group metal selected from platinum, palladium and any combination thereof in an amount of 1.0 to 10 wt. %, based on the total weight of the catalyst, zirconia nanoparticles in an amount of 3.0 to 15 wt. %, based on the total weight of the catalyst, and an alumina component as a carrier, wherein the weight ratio of the metal oxide nanoparticles to the alumina component is in the range of 1:1.5 to 1:7, wherein the platinum group metal and the zirconia nanoparticles are homogeneously dispersed on the alumina component, wherein the platinum group metal is in intimate contact with zirconia nanoparticles, wherein said nanoparticles have a D₉₀ diameter in the range of 1.0 nm to 50 nm.

In another embodiment, the catalyst of the presently claimed invention comprises a platinum group metal selected from platinum, palladium and any combination thereof in an amount of 1.0 to 10 wt. %, based on the total weight of the catalyst, zirconia nanoparticles in an amount of 3.0 to 15 wt. %, based on the total weight of the catalyst, and an alumina component as a carrier, wherein the weight ratio of the metal oxide nanoparticles to the alumina component is in the range of 1:1.5 to 1:7, wherein the platinum group metal and the zirconia nanoparticles are homogeneously dispersed on the alumina component, wherein the platinum group metal is in intimate contact with zirconia nanoparticles, wherein said nanoparticles have a D₉₀ diameter in the range of 5.0 nm to 20 nm.

In one illustrative embodiment, the catalyst of the presently claimed invention comprises palladium in an amount of 1.0 to 10 wt. %, based on the total weight of the catalyst, zirconia nanoparticles in an amount of 3.0 to 15 wt. %, based on the total weight of the catalyst, and an alumina component as a carrier, wherein the weight ratio of the zirconia nanoparticles to the alumina component is in the range of 1:1.5 to 1:7, wherein palladium and the zirconia nanoparticles are homogeneously dispersed on the carrier, wherein palladium is in intimate contact with zirconia nanoparticles, wherein said nanoparticles have a D₉₀ diameter in the range of 1.0 nm to 50 nm.

In one illustrative embodiment, the catalyst of the presently claimed invention comprises palladium in an amount of 1.0 to 10 wt. %, based on the total weight of the catalyst, zirconia nanoparticles in an amount of 3.0 to 15 wt. %, based on the total weight of the catalyst, and an alumina component as a carrier, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with zirconia nanoparticles, wherein said nanoparticles have a D₉₀ diameter in the range of 5.0 nm to 20 nm.

In one illustrative embodiment, the catalyst of the presently claimed invention comprises palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component as a carrier, wherein palladium, platinum and the zirconia nanoparticles are homogeneously dispersed on the carrier, wherein the weight ratio of the zirconia nanoparticles to the alumina component is in the range of 1:1.5 to 1:7, wherein palladium and platinum are in intimate contact with zirconia nanoparticles, wherein said nanoparticles have a D₉₀ diameter in the range of 1 nm to 50 nm.

In one illustrative embodiment, the catalyst of the presently claimed invention comprises palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component as a carrier, wherein the weight ratio of the zirconia nanoparticles to the alumina component is in the range of 1:1.5 to 1:7, wherein palladium, platinum and the zirconia nanoparticles are homogeneously dispersed on the carrier, wherein palladium and platinum are in intimate contact with zirconia nanoparticles, wherein said nanoparticles have a D₉₀ diameter in the range of 5.0 nm to 20 nm.

In one embodiment, the platinum group metal and the metal oxide nanoparticles that are dispersed on the carrier are thermally or chemically fixed.

The thermal fixing involves deposition of the PGM onto a support, e.g. via incipient wetness impregnation method, followed by the thermal calcination of the resulting PGM/support mixture. As an example, the mixture is calcined for 1-3 hours at 400-700° C. with a ramp rate of 1-25° C./min.

The chemical fixing involves deposition of the PGM onto a support followed by a fixation using an additional reagent to chemically transform the PGM. As an example, aqueous Pd-nitrate is impregnated onto alumina. The impregnated powder is not dried or calcined, instead, it is added to an aqueous solution of Ba-hydroxide. As a result of the addition, the acidic Pd-nitrate reacts with the basic Ba-hydroxide yielding the water-insoluble Pd-hydroxide and Ba-nitrate. Thus, Pd is chemically fixed as an insoluble component in the pores and on the surface of the alumina support. Alternatively, the support can be impregnated with the acidic component first followed by the second, basic, component. The chemical reaction between the two reagents deposited onto the support, e.g. alumina, lead to the formation of insoluble or little soluble compounds that are also deposited in the support pores and on the surface.

In accordance with another aspect, the presently claimed invention provides a process for the preparation of a catalyst. In one embodiment, the process comprises i) dispersing at least one platinum group metal selected from palladium, platinum and rhodium into colloidal metal oxide nanoparticles having a D₉₀ diameter in the range of 1.0 nm to 50 nm to obtain a mixture; and ii) co-impregnating said mixture on an alumina component to obtain a catalyst. The process is characterized in that the platinum group metal and the metal oxide nanoparticles are homogeneously dispersed on the alumina component, and the platinum group metal(s) is in intimate contact with the metal oxide nanoparticles.

In one embodiment, the process for the preparation of a catalyst comprises i) dispersing palladium into colloidal metal oxide nanoparticles having a D₉₀ diameter in the range of 1.0 nm to 50 nm to obtain a mixture; and ii) co-impregnating said mixture on an alumina to obtain a catalyst. The process is characterized in that the palladium and the metal oxide nanoparticles are homogeneously dispersed on the carrier, and Pd is in intimate contact with the metal oxide nanoparticles.

In one embodiment, the process further comprises a step of thermal or chemical fixing of the platinum group metal and/or the metal oxide nanoparticles on the carrier.

In one embodiment, the process for the preparation of a catalyst comprises i) dispersing palladium into colloidal metal oxide nanoparticles having a D₉₀ diameter in the range of 1.0 nm to 50 nm to obtain a mixture; and ii) co-impregnating said mixture on an alumina followed by thermal fixing to obtain a catalyst. The process is characterized in that the palladium and the metal oxide nanoparticles are homogeneously dispersed on the carrier, and Pd is in intimate contact with the metal oxide nanoparticles.

In one embodiment, the process comprises addition of at least one alkaline earth metal oxide comprising barium oxide, strontium oxide, lanthanum oxide or any combination thereof, in an amount of 1.0 to 20 wt. %, based on the total weight of the catalyst.

In one embodiment, the process comprises co-impregnation of the Pd precursor and the colloidal ZrO₂ sol material onto an alumina component, followed by calcination (550° C. for 2 hrs.) before a slurry preparation and wash coating onto a honeycomb ceramic substrate. The purpose of using ZrO₂ sol materials as a Pd promoter is to create highly dispersed Pd species on nano ZrO₂ and expect these nano-on-nano entities to be highly dispersed on Al₂O₃ based support after aging, thus promoting the TWC performance. Various catalyst materials are prepared with or without colloidal ZrO₂ and are analysed. Comparative Transmission Electron Microscopic (TEM) analysis and Energy-Dispersive x-ray Spectroscopy (EDS) analysis are provided in FIGS. 5 and 6 respectively. FIG. 5a illustrates a TEM image of a catalyst material with 1.5 wt % Pd aged at 950° C. for 5 hrs.; FIG. 5b illustrates a TEM image of a catalyst material with 1.5 wt % Pd and 8 wt % colloidal ZrO₂ (5-20 nm) aged at 950° C. for 5 hrs.; and FIG. 5c illustrates a TEM image of a catalyst material with 1.5 wt % Pd and 8 wt % large-sized ZrO₂ (100 nm) aged at 950° C. for 5 hrs. FIG. 6a illustrates a STEM-EDS image of a catalyst material with 1.5 wt % Pd aged at 950° C. for 5 hrs.; FIG. 6b illustrates a STEM-EDS image of a catalyst material with 1.5 wt % Pd and 8 wt % colloidal ZrO₂ (5-20 nm) aged at 950° C. for 5 hrs.; and FIG. 6c illustrates a STEM-EDS image of a catalyst material with 1.5 wt % Pd and 8 wt % large-sized ZrO₂ (100 nm) aged at 950° C. for 5 hrs. The homogeneous dispersion of the platinum group metal and the metal oxide nanoparticle on the carrier can be seen in FIG. 5b and FIG. 6b. i.e. dispersion of ZrO₂ is very fine and uniform across the Al₂O₃ support, whereas FIGS. 5c and 6c illustrates non-uniform and segregated ZrO₂ phase on the Al₂O₃ support.

In accordance with another aspect of the presently claimed invention, there is also provided a layered automotive catalytic article comprising the automotive catalyst of the presently claimed invention deposited on a substrate. The catalyst can be present in the bottom layer (first layer) or top layer (second layer) or both the layers. i.e. the catalyst of the presently claimed invention is deposited as a top layer or bottom layer on the substrate selected from a flow through or wall flow metallic substrate, and a flow through or wall flow ceramic substrate. In one embodiment, the catalyst is deposited on a substrate optionally along with at least one second platinum group metal such as palladium, platinum or rhodium. In one embodiment, the amount of palladium loading is 0.005 to 0.15 g/in³, the amount of rhodium loading is 0.001 to 0.02 g/in³, the amount of platinum loading is 0.005 to 0.15 g/in³, the amount of metal oxide nanoparticles loading is 0.005 to 0.25 g/in³, and the amount of carrier loading is 0.5 to 3 g/in³.

The term “catalytic article” or “catalyst article” refers to a component in which a substrate is coated with a catalyst composition or a catalyst which is used to promote a desired reaction.

As used herein, the term “substrate” refers to the monolithic material onto which the catalyst composition is placed, typically in the form of a washcoat containing a plurality of particles containing a catalytic composition thereon.

Reference to “monolithic substrate” or “honeycomb substrate” means a unitary structure that is homogeneous and continuous from the inlet to the outlet.

In one embodiment, the substrate is selected from a flow through or wall flow metallic substrate, and a flow through or wall flow ceramic substrate.

The catalyst article is used as a washcoat catalyst. As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated.

A washcoat is formed by preparing a slurry containing a certain solid content (e.g., 20-60% by weight) of particles in a liquid vehicle, which is then coated onto a substrate and dried to provide a washcoat layer.

As used herein and as described in Heck, Ronald and Farrauto, Robert, Catalytic Air Pollution Control, New York: Wiley-Inter science, 2002, pp. 18-19, a washcoat layer includes a compositionally distinct layer of material disposed on the surface of a monolithic substrate or an underlying washcoat layer. In one embodiment, a substrate contains one or more washcoat layers, and each washcoat layer is different in some way (e.g., may differ in physical properties thereof such as, for example particle size or crystallite phase) and/or may differ in the chemical catalytic functions.

The catalyst article may be “fresh” meaning it is new and has not been exposed to any heat or thermal stress for a prolonged period of time. “Fresh” may also mean that the catalyst was recently prepared and has not been exposed to any exhaust gases. Likewise, an “aged” catalyst article is not new and has been exposed to exhaust gases and elevated temperature (i.e. greater than 500° C.) for a prolonged period of time (i.e., greater than 3 hours).

According to one or more embodiments, the substrate of the catalytic article of the presently claimed invention may be constructed of any material typically used for preparing automotive catalysts and typically comprises a ceramic or a metal monolithic honeycomb structure. The substrate typically provides a plurality of wall surfaces upon which washcoats comprising the catalyst compositions described herein above are applied and adhered, thereby acting as a carrier for the catalyst compositions.

Exemplary metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy, e.g. 10-25 wt. % of chromium, 3.0-8.0% of aluminium, and up to 20 wt. % of nickel. The alloys may also contain small or trace amounts of one or more metals such as manganese, copper, vanadium, titanium and the like. The surface of the metal substrate may be oxidized at high temperature, e.g. 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-a alumina, silicon nitride, zircon mullite, spodumene, alumina-silica magnesia, zircon silicate, sillimanite, magnesium silicates, zircon, petalite, alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially available flow-through substrate is a cordierite substrate having 400 cpsi and a wall thickness of 6.0 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 600 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls.

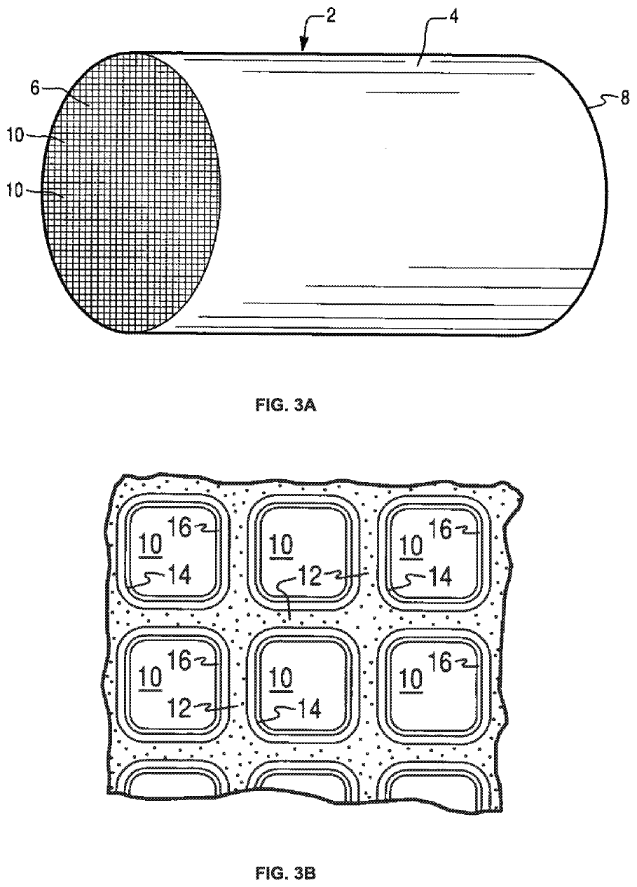

FIGS. 3A and 3B illustrate an exemplary substrate 2 in the form of a flow-through substrate coated with washcoat compositions as described herein. Referring to FIG. 3A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 3B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 3, walls 12 are so dimensioned and configured that gas flow passages 10 have a substantially regular polygonal shape. As shown, the washcoat compositions can be applied in multiple, distinct layers, if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

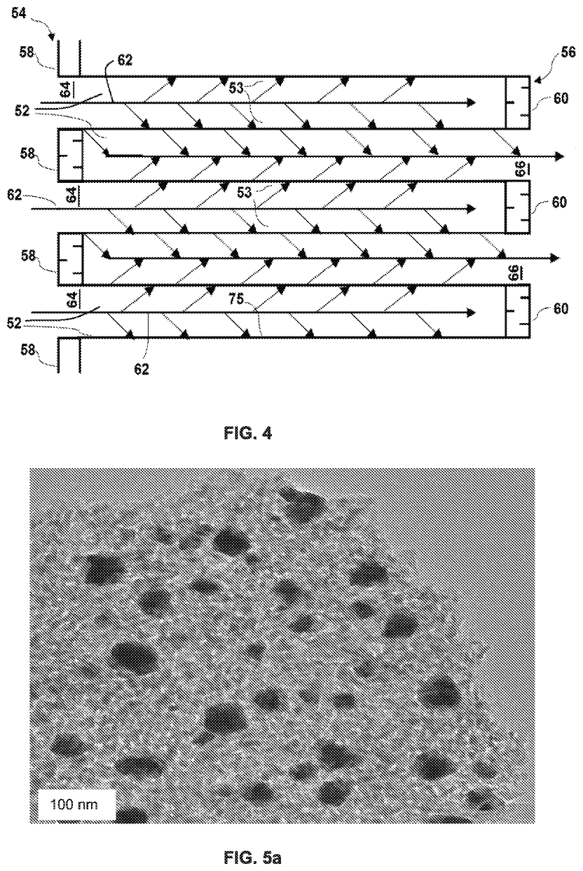

FIG. 4 illustrates an exemplary substrate 2 in the form of a wall flow filter substrate coated with a washcoat composition as described herein. As seen in FIG. 4, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalyzed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element. The presently claimed invention is explained with the help of following non-limiting embodiments.

In one embodiment, the catalytic article comprises:

a) a bottom layer comprising a catalyst comprising i) a platinum group metal selected from palladium, platinum, and any combination thereof in an amount of 1.0 to 10 wt. %, based on the total weight of the catalyst, ii) metal oxide nanoparticles in an amount of 1.0 to 20 wt. %, based on the total weight of the catalyst; and iii) an alumina component carrier,

wherein the weight ratio of the metal oxide nanoparticles to the alumina component is in the range of 1:1.5 to 1:10, wherein the platinum group metal and the metal oxide nanoparticles are homogeneously dispersed on the alumina support,
wherein said nanoparticles have a D₉₀ diameter in the range of 1.0 nm to 50 nm measured by Transmission Electron Microscopy (TEM);

b) a top layer comprising at least one platinum group metal comprising palladium, platinum, rhodium or any mixture thereof, and at least one support selected from an alumina support, an oxygen storage component, and a zirconia component; and

c) a substrate.

The alumina support comprises alumina, lanthana-alumina, ceria-alumina, ceria-zirconia-alumina, zirconia-alumina, lanthana-zirconia-alumina, baria-alumina, baria-lanthana-alumina, baria-lanthana-neodymia-alumina, or any combination thereof.

The zirconia component comprises zirconia, lanthana-zirconia, barium-zirconia, or ceria-zirconia.

The oxygen storage component comprises ceria-zirconia, ceria-zirconia-lanthana, ceria-zirconia-yttrium, ceria-zirconia-lanthana-yttrium, ceria-zirconia-neodymium, ceria-zirconia-praseodymium, ceria-zirconia-lanthana-neodymium, ceria-zirconia-lanthana-praseodymium, ceria-zirconia-lanthana-neodymium-praseodymium, or any combination thereof.

In one embodiment, the alumina component utilized in preparing catalytic article is an alumina. In another embodiment, the alumina component is an alumina doped with a dopant, wherein the dopant is selected from lanthana, ceria, ceria-zirconia, zirconia, lanthana-zirconia, baria, baria-lanthana, baria-lanthana-neodymia, baria-ceria, ceria-zirconia and any combination thereof, wherein the amount of the dopant is in the range from 5.0 to 30 wt. %, based on the total weight of alumina.

In one embodiment, the bottom layer and/or top layer comprises at least one alkaline earth metal oxide comprising barium oxide, strontium oxide, lanthanum oxide or any combination thereof, in an amount of 1.0 to 20 wt. %, based on the total weight of the bottom or top layer.

In another embodiment, the catalytic article comprises:

a) a bottom layer comprising a catalyst comprising i) palladium in an amount of 1.0 to 10 wt. %, based on the total weight of the catalyst, ii) zirconia nanoparticles in an amount of 3.0 to 15 wt. %, based on the total weight of the catalyst, and iii) an alumina component, wherein the weight ratio of the zirconia nanoparticles to the alumina component is in the range of 1:1.5 to 1:10,

wherein palladium and the zirconia nanoparticles are homogeneously dispersed on the alumina component,
wherein palladium is in intimate contact with the zirconia nanoparticles,
wherein said zirconia nanoparticles have a D₉₀ diameter in the range of 5.0 nm to 20 nm;

b) a top layer comprising at least one platinum group metal comprising palladium, platinum, rhodium or any mixture thereof, and at least one support selected from an alumina support, an oxygen storage component, a zirconia component; and

c) a substrate.

In one exemplary embodiment, the catalytic article comprises:

a) a bottom layer comprising a catalyst comprising i) palladium in an amount of 1.0 to 10 wt. %, based on the total weight of the catalyst, ii) zirconia nanoparticles in an amount of 3.0 to 15 wt. %, based on the total weight of the catalyst, and iii) an alumina component, wherein the weight ratio of the metal oxide nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles, wherein said zirconia nanoparticles have a D₉₀ diameter in the range of 5.0 nm to 20 nm;

b) a top layer comprising rhodium supported on an oxygen storage component and/or alumina component; and

c) a substrate.

In still another embodiment, the catalytic article comprises:

a) a bottom layer comprising a catalyst comprising i) palladium in an amount of 1.0 to 10 wt. %, based on the total weight of the catalyst, ii) zirconia nanoparticles in an amount of 3.0 to 15 wt. %, based on the total weight of the catalyst, and iii) an alumina component,

wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles,
wherein said nanoparticles have a D₉₀ diameter in the range of 5.0 nm to 20 nm;

b) a top layer comprising rhodium supported on an oxygen storage component and/or an alumina component and platinum supported on any of an alumina component, an oxygen storage component, and a zirconia component; and

c) a substrate.

In one exemplary embodiment, the catalytic article comprises:

a) a bottom layer comprising a catalyst comprising i) palladium in an amount of 1.0 to 10 wt. %, based on the total weight of the catalyst, ii) zirconia nanoparticles in an amount of 3.0 to 15 wt. %, based on the total weight of the catalyst, and iii) an alumina, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles, wherein said nanoparticles have a D₉₀ diameter in the range of 5.0 nm to 20 nm;

b) a top layer comprising rhodium supported on an oxygen storage component and alumina component, and platinum supported on any of an alumina component, an oxygen storage component, and a zirconia component; and

c) a substrate.

In one exemplary embodiment, the catalytic article comprises:

a) a bottom layer comprising a catalyst comprising i) palladium in an amount of 1.0 to 10 wt. %, based on the total weight of the catalyst, platinum in an amount of 1.0 to 10 wt. %, based on the total weight of the catalyst and zirconia nanoparticles in an amount of 3.0 to 15 wt. %, based on the total weight of the catalyst,

wherein the weight ratio of the zirconia nanoparticles to the alumina component is in the range of 1:1.5 to 1:7,

wherein palladium, platinum and the zirconia nanoparticles are homogeneously dispersed on the alumina component, wherein palladium and platinum are in intimate contact with the zirconia nanoparticles, wherein said zirconia nanoparticles have a D₉₀ diameter in the range of 5.0 nm to 20 nm;

b) a top layer comprising:

rhodium supported on an oxygen storage component and/or an alumina component; and

a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component,

wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles

wherein said zirconia nanoparticles have a D₉₀ diameter in the range of 5.0 nm to 20 nm; and

c) a substrate.

In one exemplary embodiment, the catalytic article comprises:

a) a bottom layer comprising:
i) a catalyst comprising palladium in an amount of 1.0 to 10 wt. %, based on the total weight of the catalyst, zirconia nanoparticles in an amount of 1.0 to 10 wt. %, based on the total weight of the catalyst, and an alumina component,
wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles,
wherein said zirconia nanoparticles have a D₉₀ diameter in the range of 5.0 nm to 20 nm,
ii) palladium supported on an oxygen storage component, and
iii) barium oxide;

b) a top layer comprising:
i) rhodium supported on an oxygen storage component, and
ii) rhodium supported on an alumina component; and

c) a substrate.

In one exemplary embodiment, the catalytic article comprises:

a) a bottom layer comprising:
i) a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component,
   wherein the weight ratio of the zirconia nanoparticles to the alumina component is in the range of 1:1.5 to 1:7,
   wherein palladium and the zirconia nanoparticles are homogeneously dispersed on an alumina component,
   wherein palladium is in intimate contact with the zirconia nanoparticles,
   wherein said zirconia nanoparticles have a D₉₀ diameter in the range of 5.0 nm to 20 nm,
ii) palladium supported on an oxygen storage component,
iii) barium oxide, and
iv) lanthanum oxide;

b) a top layer comprising rhodium supported on an alumina and oxygen storage component; and

c) a substrate.

In one exemplary embodiment, the catalytic article comprises:

a) a bottom layer comprising:

i. a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component,
wherein the weight ratio of the zirconia nanoparticles to the alumina component is in the range of 1:1.5 to 1:7,
wherein palladium, platinum and the zirconia nanoparticles are homogeneously dispersed on the alumina component,
wherein palladium and platinum are in intimate contact with the zirconia nanoparticles,
wherein said zirconia nanoparticles have a D₉₀ diameter in the range of 5.0 nm to 20 nm,

ii. palladium supported on an oxygen storage component,

iii. barium oxide, and

iv. lanthanum oxide;

b) a top layer comprising i) rhodium supported on an alumina and oxygen storage component, ii) a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component, wherein the weight ratio of the zirconia nanoparticles to the alumina component is in the range of 1:1.5 to 1:7, wherein palladium, platinum and the zirconia nanoparticles are homogeneously dispersed on the alumina component, wherein palladium and platinum are in intimate contact with the zirconia nanoparticles, wherein said zirconia nanoparticles have a D₉₀ diameter in the range of 5.0 nm to 20 nm; and

c) a substrate.

In one exemplary embodiment, catalytic article comprises:

a) a bottom layer comprising a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles, wherein said zirconia nanoparticles have a D₉₀ diameter in the range of 5.0 nm to 20 nm;

b) a top layer comprising:
i. rhodium supported on an oxygen storage component and/or an alumina component; and
ii. a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,
   wherein said zirconia nanoparticles have a D₉₀ diameter in the range of 5.0 nm to 20 nm; and

c) a substrate.

In one exemplary embodiment, catalytic article comprises:

a) a bottom layer comprising a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,

wherein said zirconia nanoparticles have a D₉₀ diameter in the range of 5.0 nm to 20 nm;

b) a top layer comprising:
i. rhodium supported on an oxygen storage component and an alumina; and
ii. a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,
   wherein said nanoparticles have a D₉₀ diameter in the range of 5.0 nm to 20 nm; and

c) a substrate.

In one exemplary embodiment, the catalytic article comprises:

a) a bottom layer comprising a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,
wherein said zirconia nanoparticles have a D₉₀ diameter in the range of 5.0 nm to 20 nm;

b) a top layer comprising:
i. rhodium supported on an oxygen storage component and/or an alumina component;
ii. platinum supported on any of an alumina component, an oxygen storage component, and a zirconia component; and
iii. a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,
wherein said zirconia nanoparticles have a D₉₀ diameter in the range of 5.0 nm to 20 nm; and

c) a substrate.

In one exemplary embodiment, the catalytic article comprises:

a) bottom layer comprising a catalyst comprising palladium in an amount of 1.0 to 10 wt. %, based on the total weight of the catalyst, and zirconia nanoparticles in an amount of 3.0 to 15 wt. %, based on the total weight of the catalyst,
wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,

wherein said nanoparticles have a D₉₀ diameter in the range of 5.0 nm to 20 nm,

b) a top layer comprising:
i. rhodium supported on an oxygen storage component and alumina;
ii. platinum supported on any of an alumina component, an oxygen storage component, and a zirconia component; and
iii. a catalyst comprising palladium in an amount of 1.0 to 10 wt. %, based on the total weight of the catalyst, and zirconia nanoparticles in an amount of 3.0 to 15 wt. %, based on the total weight of the catalyst, both homogeneously dispersed on an alumina,
wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,
wherein said nanoparticles have a D₉₀ diameter in the range of 5.0 nm to 20 nm and;

c) a substrate.

In one exemplary embodiment, the catalytic article comprises:

a) a bottom layer comprising:
i) a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component,
   wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,
   wherein said nanoparticles have a D₉₀ diameter in the range of 5.0 nm to 20 nm, and
ii) palladium supported on an oxygen storage component;

b) a top layer comprising i) rhodium supported on an oxygen storage component and/or an alumina component, and ii) a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component, wherein the weight ratio of the zirconia nanoparticles to the alumina component is in the range of 1:1.5 to 1:7,

wherein palladium and the zirconia nanoparticles are homogeneously dispersed on the alumina component,
wherein palladium is in intimate contact with the zirconia nanoparticles,
wherein said zirconia nanoparticles have a D₉₀ diameter in the range of 5.0 nm to 20 nm; and

c) a substrate.

In one exemplary embodiment, the catalytic article comprises:

a) a bottom layer comprising:
i. a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component,
wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles,
wherein said zirconia nanoparticles have a D₉₀ diameter in the range of 5.0 nm to 20 nm.
ii. palladium supported on an oxygen storage component, and
iii. barium oxide;

b) a top layer comprising i) rhodium supported on an oxygen storage component and/or an alumina component, and ii) a catalyst comprising palladium in an amount of 1.0 to 10 wt. %, based on the total weight of the catalyst, zirconia nanoparticles in an amount of 3.0 to 15 wt. % based on the total weight of the catalyst, and an alumina; and

c) a substrate.

In one exemplary embodiment, the catalytic article comprises:

a) a bottom layer comprising i) a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles,

wherein said zirconia nanoparticles have a D₉₀ diameter in the range of 5.0 nm to 20 nm, and ii) palladium supported on an oxygen storage component,

b) a top layer comprising:
i) rhodium and palladium supported on an oxygen storage component and/or an alumina support; and
ii) a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles, wherein said zirconia nanoparticles have a D₉₀ diameter in the range of 5.0 nm to 20 nm; and

c) a substrate.

In one exemplary embodiment, the catalytic article comprises:

a) a bottom layer comprising i) a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles, wherein said nanoparticles have a D₉₀ diameter in the range of 5.0 nm to 20 nm, ii) palladium supported on an oxygen storage component, and iii) barium oxide,

b) a top layer comprising i) rhodium and palladium supported on an oxygen storage component and/or an alumina support; and ii) a catalyst comprising palladium in an amount of 1.0 to 10 wt. %, based on the total weight of the catalyst, and zirconia nanoparticles in an amount of 3.0 to 15 wt. %, based on the total weight of the catalyst, and an alumina component wherein the weight ratio of the zirconia nanoparticles to the alumina component is in the range of 1:1.5 to 1:7,
wherein palladium and the zirconia nanoparticles are homogeneously dispersed on the alumina component,
wherein palladium is in intimate contact with the zirconia nanoparticles, wherein said zirconia nanoparticles have a D₉₀ diameter in the range of 5.0 nm to 20 nm; and

c) a substrate.

In one exemplary embodiment, the catalytic article comprises:

a) a bottom layer comprising i) a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component, wherein the weight ratio of the zirconia nanoparticles to the alumina component is in the range of 1:1.5 to 1:7,
wherein palladium and the zirconia nanoparticles are homogeneously dispersed on the alumina component,

wherein palladium is in intimate contact with the zirconia nanoparticles, wherein said zirconia nanoparticles have a D₉₀ diameter in the range of 5.0 nm to 20 nm; ii) palladium supported on an oxygen storage component, and iii) barium oxide;

b) the top layer comprising: i) rhodium supported on an oxygen storage component and/or an alumina component, ii) a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component, wherein the weight ratio of the zirconia nanoparticles to the alumina component is in the range of 1:1.5 to 1:7,
wherein palladium and the zirconia nanoparticles are homogeneously dispersed on the alumina component,

wherein palladium is in intimate contact with the zirconia nanoparticles, wherein said zirconia nanoparticles have a D₉₀ diameter in the range of 5.0 nm to 20 nm; and

c) a substrate.

In one exemplary embodiment, the catalytic article comprises:

a) bottom layer comprising i) a catalyst comprising palladium in an amount of 1.0 to 10 wt. %, based on the total weight of the catalyst, zirconia nanoparticles in an amount of 3.0 to 15 wt. %, based on the total weight of the catalyst, and an alumina component wherein the weight ratio of the zirconia nanoparticles to the alumina component is in the range of 1:1.5 to 1:7,
wherein palladium and the zirconia nanoparticles are homogeneously dispersed on the alumina component,

wherein palladium is in intimate contact with the zirconia nanoparticles, wherein said zirconia nanoparticles have a D₉₀ diameter in the range of 5.0 nm to 20 nm, ii) palladium supported on an oxygen storage component, iii) barium oxide, and iv) lanthanum oxide;

b) a top layer comprising:
i. rhodium and palladium supported on an oxygen storage component and/or an alumina component;
ii. a catalyst comprising palladium in an amount of 1.0 to 10 wt. %, based on the total weight of the catalyst, and zirconia nanoparticles in an amount of 3.0 to 15 wt. %, based on the total weight of the catalyst, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles, wherein said zirconia nanoparticles have a D₉₀ diameter in the range of 5.0 nm to 20 nm,
iii. barium oxide, and
iv. lanthanum oxide; and

c) a substrate.

In one exemplary embodiment, the catalytic article comprises:

a) a bottom layer comprising a catalyst comprising palladium in an amount of 1.0 to 10 wt. %, based on the total weight of the catalyst, and zirconia nanoparticles in an amount of 3.0 to 15 wt. %, based on the total weight of the catalyst,

wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles,

wherein said zirconia nanoparticles have a D₉₀ diameter in the range of 5.0 nm to 20 nm;

b) a top layer comprising:
i. rhodium supported on an oxygen storage component and/or an alumina component; and
ii. a catalyst comprising platinum in an amount of 1.0 to 10 wt. %, based on the total weight of the catalyst, palladium in an amount of 1.0 to 10 wt. %, based on the total weight of the catalyst, zirconia nanoparticles in an amount of 3.0 to 15 wt. %, based on the total weight of the catalyst, and an alumina component,
wherein the weight ratio of the zirconia nanoparticles to the alumina component is in the range of 1:1.5 to 1:7, wherein palladium and the zirconia nanoparticles are homogeneously dispersed on the alumina component, wherein palladium and platinum are in intimate contact with the zirconia nanoparticles,
wherein said nanoparticles have a D₉₀ diameter in the range of 5.0 nm to 20 nm; and

c) a substrate.

In one exemplary embodiment, the catalytic article comprises:

a) a bottom layer comprising a catalyst comprising palladium in an amount of 1.0 to 10 wt. %, based on the total weight of the catalyst, platinum in an amount of 1.0 to 10 wt. %, based on the total weight of the catalyst zirconia nanoparticles in an amount of 3.0 to 15 wt. %, based on the total weight of the catalyst, and an alumina component,

wherein the weight ratio of the zirconia nanoparticles to the alumina component is in the range of 1:1.5 to 1:7, wherein platinum, palladium and the zirconia nanoparticles are homogeneously dispersed on the alumina component, wherein palladium is in intimate contact with the zirconia nanoparticles, wherein said zirconia nanoparticles have a D₉₀ diameter in the range of 5.0 nm to 20 nm;
b) a top layer comprising:
i. rhodium supported on an oxygen storage component and/or an alumina component; and
ii. a catalyst comprising platinum in an amount of 1.0 to 10 wt. %, based on the total weight of the catalyst, palladium in an amount of 1.0 to 10 wt. %, based on the total weight of the catalyst, zirconia nanoparticles in an amount of 3.0 to 15 wt. %, based on the total weight of the catalyst and an alumina component,

wherein the weight ratio of the zirconia nanoparticles to the alumina component is in the range of 1:1.5 to 1:7, wherein platinum, palladium and the zirconia nanoparticles are homogeneously dispersed on the alumina component, wherein palladium and platinum are in intimate contact with the zirconia nanoparticles,

wherein said nanoparticles have a D₉₀ diameter in the range of 5.0 nm to 20 nm.

In one exemplary embodiment, the catalytic article comprises:

a) a bottom layer comprising i) a catalyst comprising palladium in an amount of 1.0 to 10 wt. %, based on the total weight of the catalyst, zirconia nanoparticles in an amount of 1.0 to 10 wt. %, based on the total weight of the catalyst, and an alumina component, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles, ii) palladium supported on an oxygen storage component, and iii) barium oxide;

b) a top layer comprising:
i. rhodium supported on an oxygen storage component; and
ii. a catalyst comprising platinum in an amount of 1.0 to 10 wt. %, based on the total weight of the catalyst, palladium in an amount of 1.0 to 10 wt. %, based on the total weight of the catalyst, zirconia nanoparticles in an amount of 3.0 to 15 wt. %, based on the total weight of the catalyst and an alumina component, wherein the weight ratio of the zirconia nanoparticles to the alumina component is in the range of 1:1.5 to 1:7, wherein platinum, palladium and the zirconia nanoparticles are homogeneously dispersed on the alumina component, wherein palladium and platinum are in intimate contact with the zirconia nanoparticles,
wherein said zirconia nanoparticles have a D₉₀ diameter in the range of 5.0 nm to 20 nm; and

c) a substrate.

In one exemplary embodiment, the catalytic article comprises:

a) a bottom layer comprising i) a catalyst comprising palladium in an amount of 1.0 to 10 wt. %, based on the total weight of the catalyst, zirconia nanoparticles in an amount of 3.0 to 10 wt. %, based on the total weight of the catalyst and an alumina component, wherein the weight ratio of the zirconia nanoparticles to the alumina component is in the range of 1:1.5 to 1:7, wherein palladium and the zirconia nanoparticles are homogeneously dispersed on the alumina component, wherein palladium is in intimate contact with the zirconia nanoparticles, wherein said zirconia nanoparticles have a D₉₀ diameter in the range of 5.0 nm to 20 nm, ii) palladium supported on an oxygen storage component, and iii) barium oxide,

wherein the top layer comprises: a) rhodium supported on an oxygen storage component, b) a catalyst comprising platinum in an amount of 1.0 to 10 wt. %, based on the total weight of the catalyst, palladium in an amount of 1.0 to 10 wt. %, based on the total weight of the catalyst, and zirconia nanoparticles in an amount of 3.0 to 15 wt. %, based on the total weight of the catalyst,

wherein the weight ratio of the zirconia nanoparticles to the alumina component is in the range of 1:1.5 to 1:7, wherein platinum, palladium and the zirconia nanoparticles are homogeneously dispersed on the alumina component, wherein platinum and palladium are in intimate contact with the zirconia nanoparticles, wherein said nanoparticles have a D₉₀ diameter in the range of 5.0 nm to 20 nm, and c) barium oxide; and

c) a substrate.

In one embodiment, the catalytic article comprises:

a) a bottom layer comprising a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component,

wherein the weight ratio of the zirconia nanoparticles to the alumina component is in the range of 1:1.5 to 1:7,

wherein palladium, platinum and the zirconia nanoparticles are homogeneously dispersed on the alumina component,

wherein palladium and platinum are in intimate contact with the zirconia nanoparticles,

wherein said zirconia nanoparticles have a D₉₀ diameter in the range of 5.0 nm to 20 nm;

b) a top layer comprising rhodium supported on an oxygen storage component and/or an alumina support\; and

c) a substrate.

In another embodiment, the catalytic article comprises:

a) a bottom layer comprising:
i) a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina,

wherein palladium, platinum and the zirconia nanoparticles are homogeneously dispersed on the alumina component,

wherein the weight ratio of the zirconia nanoparticles to the alumina component is in the range of 1:1.5 to 1:7,

wherein palladium and platinum are in intimate contact with the zirconia nanoparticles,
wherein said nanoparticles have a D₉₀ diameter in the range of 5.0 nm to 20 nm,
ii) palladium supported on an oxygen storage component, and
iii) barium oxide,

b) a top layer comprising:
i) rhodium supported on an oxygen storage component, and
ii) rhodium supported on an alumina component; and

c) a substrate.

In still another embodiment, the catalytic article comprises:

a) a bottom layer comprising:
i) a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component,

wherein the weight ratio of the zirconia nanoparticles to the alumina component is in the range of 1:1.5 to 1:7,

wherein palladium, palladium and the zirconia nanoparticles are homogeneously dispersed on the alumina component,

wherein palladium and platinum are in intimate contact with the zirconia nanoparticles,

wherein said zirconia nanoparticles have a D₉₀ diameter in the range of 5.0 nm to 20 nm,
ii) palladium supported on an oxygen storage component,
iii) barium oxide, and
iv) lanthanum oxide;

b) a top layer comprising rhodium supported on an alumina and oxygen storage component; and

c) a substrate.

In still another embodiment, the catalytic article comprises:

a) a bottom layer comprising:
i) a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component, wherein the weight ratio of the zirconia nanoparticles to the alumina component is in the range of 1:1.5 to 1:7,

wherein palladium, palladium and the zirconia nanoparticles are homogeneously dispersed on the alumina component,

wherein palladium and platinum are in intimate contact with the zirconia nanoparticles,

wherein said zirconia nanoparticles have a D₉₀ diameter in the range of 5.0 nm to 20 nm,
ii) palladium supported on an oxygen storage component,
iii) barium oxide, and
iv) lanthanum oxide;

b) a top layer comprising rhodium supported on an alumina support and oxygen storage component, and a catalyst comprising palladium in an amount of 1.0 to 10 wt. %, based on the total weight of the catalyst, platinum in an amount of 1.0 to 10 wt. %, based on the total weight of the catalyst, zirconia nanoparticles in an amount of 3.0 to 15 wt. %, based on the total weight of the catalyst, and an alumina component,

wherein the weight ratio of the zirconia nanoparticles to the alumina component is in the range of 1:1.5 to 1:7,

wherein palladium and platinum are in intimate contact with the zirconia nanoparticles,

wherein palladium, palladium and the zirconia nanoparticles are homogeneously dispersed on the alumina component, wherein said zirconia nanoparticles have a D₉₀ diameter in the range of 5.0 nm to 20 nm; and

c) a substrate.

In another aspect of the presently claimed invention, a process for the preparation of a layered catalytic article as described herein above is provided. In one embodiment, the process involves preparing a bottom layer slurry followed by depositing the bottom layer slurry on a substrate to obtain a bottom layer. Further, a top layer slurry is prepared and deposited on the bottom layer to obtain a top layer followed by calcination at a temperature in the range from 400 to 700° C.

In one embodiment, the process further comprises a step of calcination before depositing the top layer on the bottom layer, wherein the calcination is carried out at a temperature in the range from 400 to 700° C.

In one embodiment, the step of preparing the bottom layer slurry involves the following steps:

In the first step, at least one platinum group metal selected from palladium, platinum and rhodium is dispersed into colloidal metal oxide nanoparticles having D₉₀ diameter in the range of 1.0 nm to 50 nm to obtain a mixture; and ii) co-impregnating said mixture on an alumina component carrier to obtain a first mixture.

In the next step, at least one platinum group metal comprising platinum, rhodium, palladium or any combination thereof is deposited on at least one support selected from an alumina component and an oxygen storage component to obtain a second mixture, mixing the first mixture and the second mixture to obtain the second layer slurry.

In one embodiment, the step of preparing the top layer slurry involves depositing at least one platinum group metal comprising platinum, rhodium, palladium or any combination thereof on at least one support selected from an alumina support and an oxygen storage component.

In one embodiment, the step of preparing the bottom layer slurry or top layer slurry comprises a technique selected from incipient wetness impregnation technique (A); co-precipitation technique (B) and co-impregnation technique (C).

Incipient wetness impregnation techniques, also called capillary impregnation or dry impregnation are commonly used for the synthesis of heterogeneous materials, i.e., catalysts. Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Ru (N0)3 and salts thereof), rhodium acetate, or combinations thereof where rhodium is the active metal and palladium nitrate, palladium tetra amine, palladium acetate, or combinations thereof where palladium is the active metal. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12.

The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D₉₀ particle size of about 10 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. In one embodiment, the catalyst substrate is dipped one or more times in the slurry or otherwise coated with the slurry. Thereafter, the coated substrate is dried at an elevated temperature (e.g., 100-150° C.) for a period of time (e.g., 10 min-3 hours) and then calcined by heating, e.g., at 400-700° C., typically for about 10 minutes to about 3 hours. Following drying and calcining, the final washcoat coating layer is viewed as essentially solvent-free. After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

In certain embodiments, the coated substrate is aged, by subjecting the coated substrate to heat treatment. In one particular embodiment, aging is done at a temperature of from about 850° C. to about 1050° C. in an environment of vol. % water in air for 20 hours. Aged catalyst articles are thus provided in certain embodiments. In certain embodiments, particularly effective materials comprise metal oxide-based supports (including, but not limited to substantially 100% ceria supports) that maintain a high percentage (e.g., about 95-100%) of their pore volumes upon aging (e.g., at about 850° C. to about 1050° C., 10 vol. % water in air, 20 hours aging).

In one exemplary embodiment, the catalytic article comprising a bottom layer comprising i) palladium in an amount of 1.0 to 10 wt. %, based on the total weight of the catalyst, ii) zirconia nanoparticles having a D₉₀ diameter in the range of 5.0 nm to 20 nm in an amount of 3.0 to 15 wt. %, based on the total weight of the catalyst, and iii) an alumina component, wherein palladium and the zirconia, wherein the weight ratio of the zirconia nanoparticles to the alumina component is in the range of 1:1.5 to 1:7, wherein the nanoparticles are homogeneously dispersed on the the alumina component, wherein palladium is in intimate contact with the zirconia nanoparticles; a top layer comprising rhodium supported on ceria-zirconia and alumina; and a substrate, is prepared. The process involves the following steps: Initially, Pd precursor and colloidal ZrO₂ sol material are co-impregnated onto alumina-based support, followed by calcination (550° C. for 2 hrs.) to obtain a first mixture. Separately, palladium is impregnated on the ceria-zirconia with addition of barium oxide to obtain a second mixture. The first and second mixtures are mixed together to obtain a bottom layer slurry which is deposited on a substrate. Another slurry is prepared in which rhodium is impregnated on alumina and ceria-zirconia support and deposited on the bottom layer.

The washcoated catalysts are aged at 950° C. for 75 hours on a real engine using a fuel cut (lean-rich) protocol and tested on a vehicle using FTP-75 cycle.

The vehicle testing results clearly showed that the invention catalyst with colloidal ZrO₂ sol as a Pd promoter on an Al₂O₃ based support provides greatly improved HC and NOx performance. The optimal colloidal ZrO₂ particle size is found to be 5.0-20 nm. The larger colloidal ZrO₂ particle such as 100 nm provides no benefit or even worse the TWC performance. The characterization results showed that using the proper size of colloidal ZrO₂ sol as a Pd prompter could well increase the Pd dispersion on Al₂O₃ based supports, which is possibly due to the electronic interaction between Pd and nano-ZrO₂ and is responsible for the greatly improved TWC performance.

Results showed hydrocarbon (HC) emission reduction by 30-40% in the mid-bed and by 10-20% in the tail-pipe, and the nitrogen oxides (NOx) emission reduction by 60-70% in the mid-bed and by 30-40% in the tail-pipe compared to reference catalysts. This enhanced improvement in TWC performance by using ZrO₂ as an efficient Pd promoter is particularly beneficial for the reduction of PGM usage amount especially when the Pd price is going much higher in recent days.

In accordance with another aspect of the presently claimed invention there is provided a method of treating a gaseous exhaust stream comprising hydrocarbons, carbon monoxide, and nitrogen oxide, the method comprising contacting said exhaust stream with the catalyst or a layered catalytic article or a layered catalytic article obtained by the process according to the presently claimed invention.

In another aspect there is provided a method of reducing hydrocarbons, carbon monoxide, and nitrogen oxide levels in a gaseous exhaust stream comprising contacting the gaseous exhaust stream with a catalyst or a layered catalytic article or a layered catalytic article obtained by the presently claimed process to reduce the levels of hydrocarbons, carbon monoxide, and nitrogen oxide in the exhaust gas.

In still another aspect there is provided use of the catalyst or layered catalytic article for purifying a gaseous exhaust stream comprising hydrocarbons, carbon monoxide, and nitrogen oxide.

The presently claimed invention further provides an exhaust system for internal combustion engines comprising the catalyst or layered catalytic article disposed downstream or upstream from an internal combustion engine. In one embodiment, the layered catalytic article is used as a CC1 catalyst (close-couple catalyst) along with a conventional CC2 catalyst (close-couple catalyst) in a gasoline engine vehicle. In another embodiment, the layered catalytic article is used as a CC2 catalyst (close-couple catalyst) along with a conventional CC1 catalyst (close-couple catalyst) in a gasoline engine vehicle.

Aspects of the presently claimed invention are more fully illustrated by the following examples, which are set forth to illustrate certain aspects of the present invention and are not to be construed as limiting thereof.

### Example 1: Preparation of a Layered Three-Way Catalyst (Reference Catalyst-1, RC-1, Bottom Layer: Pd—Al, Top Layer: Rh-AVOSC)

A. Bottom Layer (First Layer) Preparation:

Palladium nitrate solution (18.52 g with Pd concentration=27.6%) was impregnated onto an alumina stabilized with 4.0% La oxide (La doped alumina=350 grams) by using an incipient wetness method. The mixture was then calcined at 550° C. for 2 hours.

Separately, palladium nitrate (18.52 grams) was impregnated onto an oxygen storage material (OSM) (481 grams: OSM: Ce=40%, Zr=60%, La 5%, Y=5% as oxides) by using the incipient wetness method. The mixture was then calcined at 550° C. for 2 hours.

Slurry Preparation:

Calcined palladium on alumina was added to water under mixing. To this, barium acetate (192.5 g) and 96 grams of zirconyl acetate were added to obtain a mixture. pH of the mixture was adjusted to 4.5-5.0 using nitric acid. The mixture was continuously milled using an Eiger mill to particle size distribution at 90% less than 20 micro meters.

To this, calcined Pd on OSM was added and pH was adjusted to 4.5 to 5.0 using nitric acid and milled to particle size distribution (PSD) at 90% less than 14 micrometers.

Finally, alumina binder (9.6 grams) was added to the mixture and mixed well. The obtained final mixture which resulted a wash coat loading of about 2.6 g/in³ was dried and calcined at 550° C. for 2 hours.

B. Top Layer (Second Layer) Preparation:

Rhodium nitrate solution (11.1 g with Rh concentration=10.2%) was impregnated onto an alumina stabilized with 4.0% La oxide (La doped alumina=481 grams) by using an incipient wetness method. The impregnated Rh on alumina was added onto water containing 102.5 grams of dispersed oxygen storage material dispersed in 390 grams of water (The oxygen storage material, CeO₂—ZrO₂ with 50% CeO₂ and 50% ZrO₂ and solid of about 70%) dispersed in 390 grams of water. The pH of the slurry was kept at about 4.5 and the slurry milled to particle size distribution at 90% less than 14 micrometers.

Rhodium nitrate solution (11.1 g with Rh concentration=10.2%) was impregnated onto 340 grams of oxygen storage material (OSC=CeO₂—ZrO₂) by using incipient wetness method. The impregnated Rh on OSC was added onto water containing 102.5 grams of dispersed oxygen storage material dispersed in 390 grams of water (The oxygen storage material, CeO₂—ZrO₂ with 50% CeO₂ and 50% ZrO₂ and solid of about 70% dispersed in 390 grams of water). The pH of the obtained slurry was kept at about 4.5 and the slurry milled to particle size distribution at 90% less than 14 micrometers.

Overall Wash Coat Loading:
Bottom layer coat: Pd=0.0256 g/in³, oxygen storage material (OSM)=1.25 g/in³, alumina=0.95 g/in³, ZrO₂=0.05 g/in³, BaO=0.3 g/in³, alumina binder=0.025 g/in³. Total bottom wash coat loading: 2.6 g/in³.
Top layer coat: Rh=0.0023 g/in³ (Rh=4 g/ft³), alumina=0.5 g/in³, OSM=0.35 ZrO₂=0.05 g/in³, alumina binder: 0.025 g/in³.
Total top wash coat loading: 1.27 g/in³.

### Example 2: Preparation of a Layered Three-Way Catalyst (Invention Catalyst-1, IC-1, Bottom Layer: Pd-Colloidal Zirconia-Al and Top Layer: Rh—Al/Zr)

A. Bottom Layer (First Layer) Preparation:

Palladium nitrate solution (28.6 g with Pd concentration=27.6%) was mixed with 98.6 grams of water dispersed colloidal zirconia solution (solid ZrO₂=30%, average particle size: ≤5.0-20 nm, measured by TEM) and impregnated onto alumina stabilized with 4.0% La oxide (La doped alumina=593 grams) by using an incipient wetness method. The mixture was then calcined at 550° C. for 2 hours.

Separately, palladium nitrate (28.5 grams) was impregnated onto an oxygen storage material (OSM) (759 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium-Zirconia on alumina was added to water under mixing. To this, barium acetate (300 g) and 98.6 grams of zirconyl acetate were added to obtain a mixture. pH of the mixture was adjusted to 4.5-5.0 using nitric acid. The mixture was continuously milled using an Eiger mill to particle size distribution at 90% less than 20 micro meters. To this, calcined Pd on OSM was added and pH was adjusted to 4.5 to 5.0 using nitric acid and milled to particle size distribution (PSD) at 90% less than 14 micrometers.

Finally, alumina binder (22.6 grams) was added to the mixture and mixed well. The obtained final mixture which resulted a wash coat loading of about 2.6 g/in³ was dried and calcined at 550° C. for 2 hours. The resultant wash coat was surface analysed by TEM and/or Energy-Dispersive x-ray Spectroscopy (EDS) and it was found that palladium and zirconia are homogeneously dispersed and fixed on the alumina carrier. FIG. 5b illustrates the homogeneous dispersion. The particle size analysed by TEM shows 5 to 20 nm sized zirconia nanoparticles.

B. Top Layer (Second Layer) Preparation:

Rhodium nitrate solution (11.1 g with Rh concentration=10.2%) was impregnated onto an alumina stabilized with 4.0% La oxide (La doped alumina=488 grams) by using an incipient wetness method. The impregnated Rh on alumina was added into water containing 102.5 grams of dispersed oxygen storage material dispersed in 390 grams of water (The oxygen storage material, CeO₂—ZrO₂ with 50% CeO₂ and 50% ZrO₂ and solid of about 70% dispersed in 390 grams of water). The pH of the obtained slurry was kept at about 4.5 and the slurry milled to particle size distribution at 90% less than 14 micrometers.

Rhodium nitrate solution (11.1 g with Rh concentration=10.2%) was impregnated onto 340 grams of oxygen storage material (OSC=CeO₂—ZrO₂) by using the incipient wetness method. The impregnated Rh on OSC was added into water containing 102.5 grams of dispersed oxygen storage material dispersed in 390 grams of water (The oxygen storage material, CeO₂—ZrO₂ with 50% CeO₂ and 50% ZrO₂ and solid of about 70% dispersed in 390 grams of water). The pH of the slurry was kept at about 4.5 and the slurry milled to particle size distribution at 90% less than 14 micrometers.

Overall Wash Coat Loading:
Bottom layer coat: Pd=0.0256 g/in³, oxygen storage material (OSM)=1.25 g/in³, colloidal ZrO₂=0.125, alumina=0.95 g/in³, BaO=0.3 g/in³, alumina binder=0.025 g/in³.
Total bottom wash coat loading: 2.7 g/in³.
Top layer coat: Rh=0.0023 g/in³ (Rh=4 g/ft³), alumina=0.5 g/in³, OSM=0.35 ZrO₂=0.05 g/in³, alumina binder: 0.025 g/in³.
Total top wash coat loading: 1.27 g/in³.

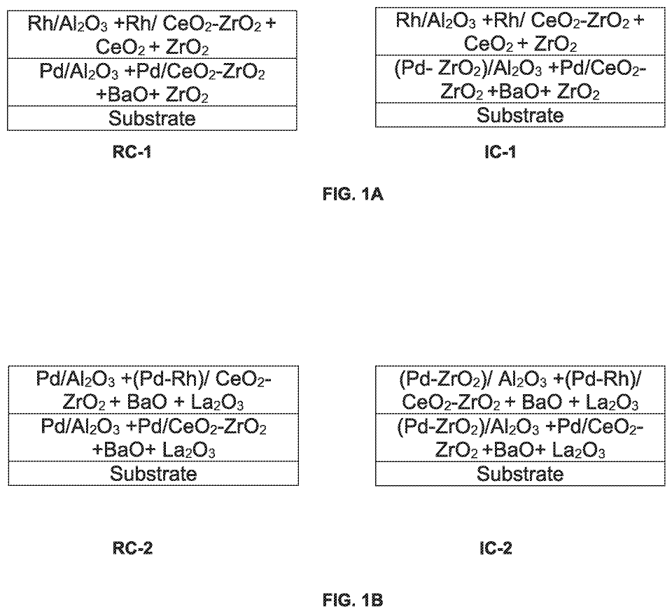

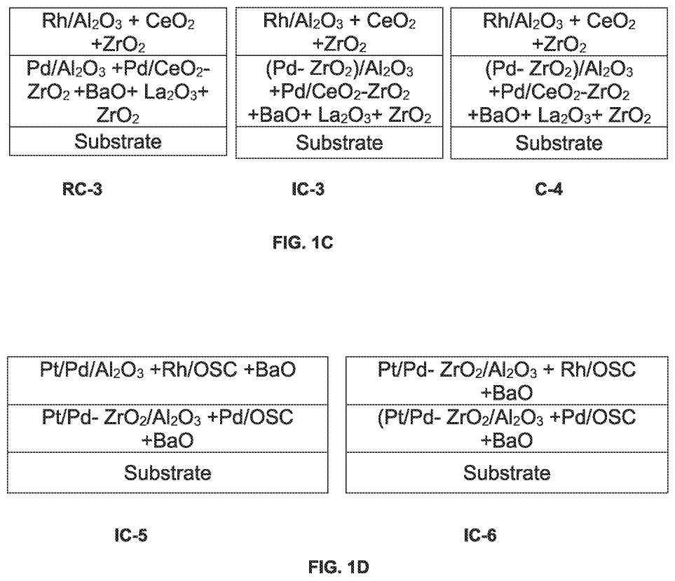

The designs of reference catalyst (RC-1) and invention catalyst (IC-1) with layering structure on a substrate are shown in FIG. 1A. The FIG. 1A illustrates that the top coat of rhodium was kept same in both the catalysts (RC-1 & IC-1), whereas the bottom coat (first layer) of both catalysts was changed. i.e. the bottom coat of the invention catalyst (IC-1) contained Pd with colloidal ZrO₂ on an Al₂O₃ based support and the bottom coat of the reference catalyst (RC-1) contained Pd on Al₂O₃ based support and is devoid of colloidal zirconia.

Comparative Testing of Reference Catalyst (RC-1) and Invention Catalyst (IC-1):

The as-prepared full part washcoated catalysts (Pd/Rh=46/4 g/ft³; 4.16″×3.0″, 600/4) were aged on an engine at 950° C. for 75 hours, and then tested as CC-1 catalysts on a vehicle for FTP-75 cycles. The CC-2 catalyst was kept the same for all testing, which was a simple Pd bottom coat and Rh top coat catalyst with Pd:Rh loading of 14/4 g/ft³.

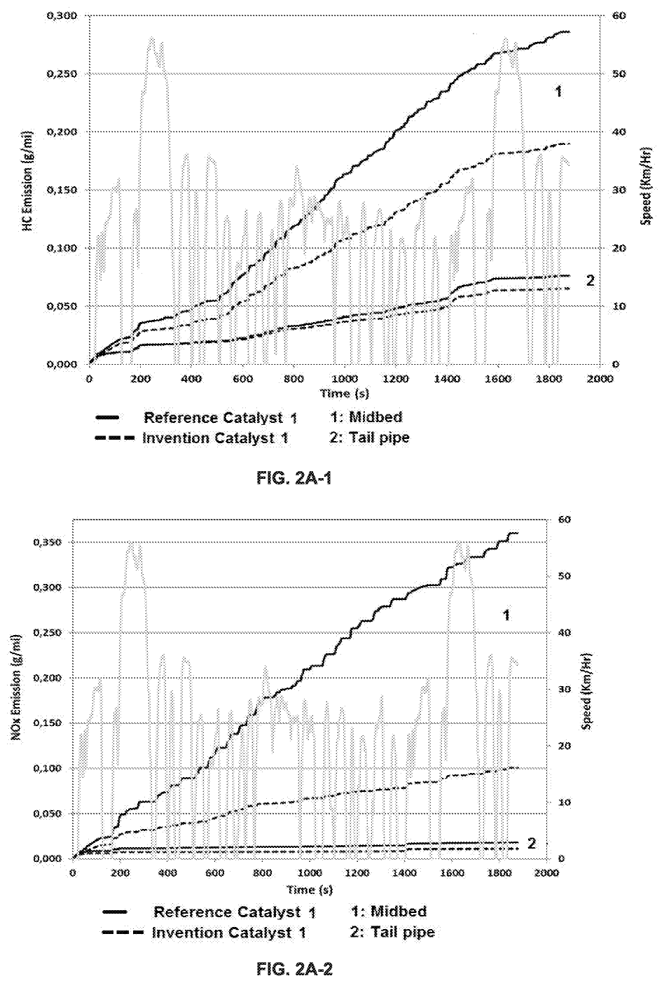

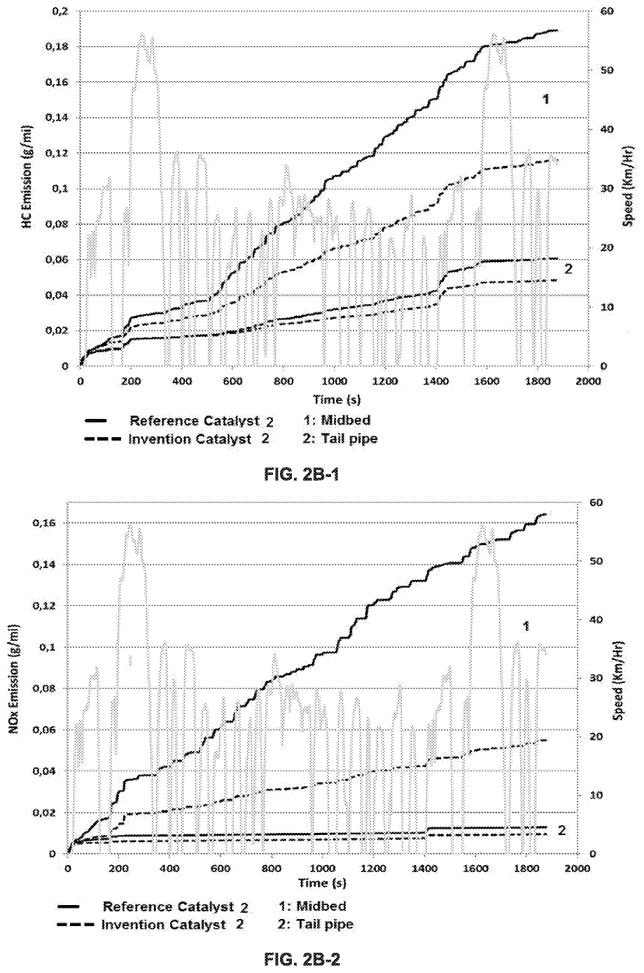

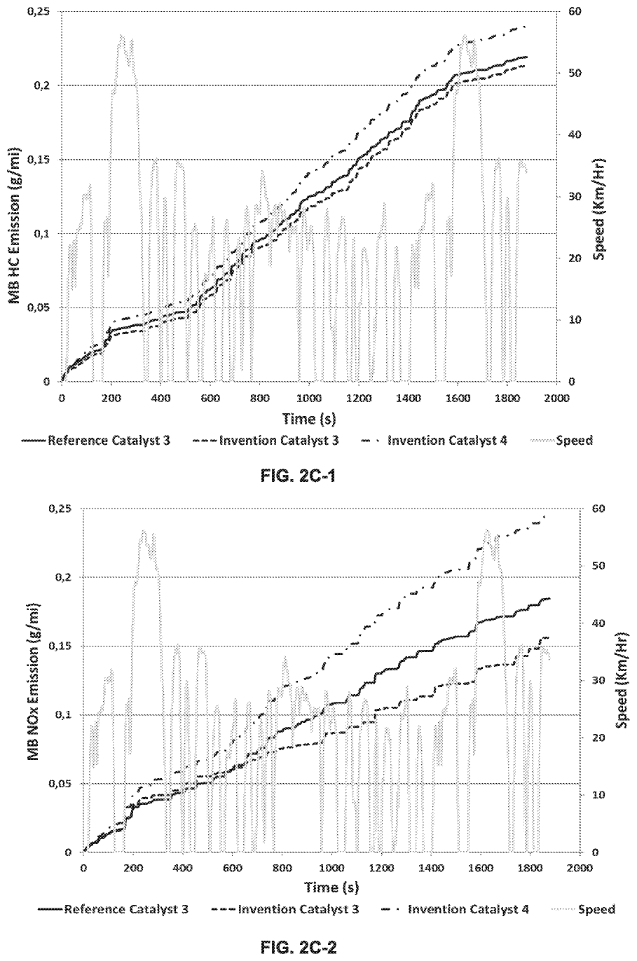

FIG. 2A shows the FTP-75 test results on a vehicle for a reference catalyst (RC-1) and invention catalyst (IC-1) for cumulative mid-bed and tail-pipe HC and NOx emission. It is clearly observed that ZrO₂ sol material which acts as a Pd promoter significantly decreased the mid-bed HC emission. The HC reduction was found to be 34%. From the tail-pipe HC emission analysis, it is found that ZrO₂ sol promoter causes 14% decrease in HC cumulative emission. Further, comparing to the reference catalyst (RC-1), the Invention catalyst (IC-1) containing ZrO₂ sol showed significant decrease in NOx emission for mid-bed. The reduction was found to be 72%. From the tail-pipe HC emission analysis, it is found that ZrO₂ sol promoter causes NOx emission reduction by 39%. Thus, based on both HC and NOx emission results, it can be clearly concluded that, the ZrO₂ sol material co-impregnated with Pd onto Al₂O₃ can increase the HC and NOx reduction performance significantly.

### Example 3: Preparation of a Layered Three-Way Catalyst (Reference Catalyst-2, RC-2, Both Top and Bottom Layers Contain Pd on Al)

A. Bottom Layer Preparation:

Palladium nitrate solution (11.46 g with Pd concentration=27.6%) was impregnated onto an alumina stabilized with 4% La oxide (La doped alumina=303 grams) by using an incipient wetness method. The mixture was then calcined at 550° C. for 2 hours.

Separately, palladium nitrate (17.2 grams) was impregnated onto an oxygen storage material (OSM, 606 grams, OSM: Ce=40%, Zr=60%, La 5.0%, Y=5.0% as oxides) by using the incipient wetness method. The mixture was then calcined at 550° C. for 2 hours.

Slurry Preparation:

Calcined palladium on alumina was added to water containing La nitrate solution (99 g, La₂O₃=30%) under mixing at pH about 4.0-4.5, add barium sulfate (91.4 g, BaO=65%). pH of the mixture was adjusted to 4.5-5.0 using nitric acid. The mixture was continuously milled using an Eiger mill to particle size distribution at 90% less than 20 micro meters. To this, calcined Pd on OSM was added and pH was adjusted to 4.5 to 5.0 using nitric acid and milled to particle size distribution (PSD) at 90% less than 14 micrometers.

Finally, alumina binder (59 @ 20% solid) was added to the mixture and mixed well. The obtained final mixture which resulted a wash coat loading of about 2.6 g/in³ was dried and calcined at 550° C. for 2 hours.

B. Top Layer (Second Layer) Preparation:

Palladium nitrate solution (19.95 g with Pd concentration=27.6%) was impregnated onto an alumina stabilized with 4.0% La oxide (La doped alumina=388 grams) by using an incipient wetness method. The mixture was then calcined at 550° C. for 2 hours.

Separately, a solution of palladium nitrate (6.65 g) and Rh nitrate (12.06 g) was impregnated onto an oxygen storage material (OSM, 528 g, OSC=10% CeO₂) by using the incipient wetness method. The mixture was then calcined at 550° C. for 2 hours.

Calcined palladium on alumina was added to water containing La nitrate solution (146 g, La₂O₃=27%) under mixing at pH about 4.0-4.5. To this barium sulfate (60 g, BaO=65%) was added. pH of the mixture was adjusted to 4.5-5.0 using nitric acid. The mixture was continuously milled using an Eiger mill to particle size distribution at 90% less than 12-14 micro meters.

Calcined palladium/rhodium on oxygen storage material (Ce-ZO₂, 10% CeO₂) was added to water and pH was adjusted with nitric acid to a pH of about 4.0-4.5. The slurry was continuously milled using an Eiger mill to particle size distribution at 90% less than 12-14 micro meters.

The obtained two slurries were mixed and pH was adjusted to about 4.0-4.5, if needed. To this mixture, alumina binder (52 @ 20% solid) was added and mixed well. The obtained final mixture which resulted a wash coat loading of about 1.9 g/in³ was dried and calcined at 550° C. for 2 hours.

Overall Wash Coat Loading:
Bottom layer coat: Pd=0.0133 g/in³, oxygen storage material (OSM)=1.0 g/in³, alumina=0.5 g/in³, BaO=0.1 g/in³, La₂O₃=0.05 g/in³, alumina binder=0.02 g/in³.
Total bottom wash coat loading: 1.68 g/in³.
Top layer coat: Rh=0.0023 g/in³ (Rh=4 g/ft³), Pd=0.0133 g/in³, alumina=0.75 g/in³, OSM=1.0 g/in³, La₂O₃=0.075 g/in³, BaO=0.075 g/in³, alumina binder: 0.025 g/in³.
Total top wash coat loading: 1.94 g/in³.

### Example 4: Preparation of a Layered Three-Way Catalyst (Invention Catalyst-2, IC-2, Both Top and Bottom Layers Contain Pd-Colloidal Zirconia-Al)

A. Bottom Layer (First Layer) Preparation:

A mixture of palladium nitrate solution (11.9 g with Pd concentration=25.8%) and 143.5 g of colloidal zirconia (20% zirconia solid, average particle size: ≤5.0-20 nm) was impregnated onto alumina stabilized with 4.0% La oxide (La doped alumina=289 g) by using an incipient wetness method. The mixture was then calcined at 550° C. for 2 hours.

Separately, palladium nitrate (17.8 grams) was impregnated onto an oxygen storage material (OSM) (590 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium-zirconia on alumina was added to water containing La nitrate solution (108.5 g, La₂O₃=30%) under mixing at pH about 4.0-4.5. To this barium sulfate (88.6 g, BaO=65%) was added. pH of the mixture was adjusted to 4.5-5 using nitric acid. The mixture was continuously milled using an Eiger mill to particle size distribution at 90% less than 20 micro meters. To this, calcined Pd on OSM was added and pH was adjusted to 4.5 to 5.0 using nitric acid and milled to particle size distribution (PSD) at 90% less than 14 micrometers.

Finally, alumina binder (58 @ 20% solid) was added to the mixture and mixed well. The obtained final mixture which resulted a wash coat loading of about 1.73 g/in³ followed by drying and calcination at 550° C. for 2 hours.

B. Top Layer (Second Layer) Preparation:

A mixture of Palladium nitrate solution (19.2 g with Pd concentration=25.8%) and colloidal zirconia (185 g at ZrO₂ solid of 20%) was impregnated onto an alumina stabilized with 4.0% La oxide (La doped alumina=373 grams) by using an incipient wetness method. The mixture was then calcined at 550° C. for 2 hours.

Separately, a solution of palladium nitrate (6.4 g) and Rh nitrate (11.6 g) was impregnated onto an oxygen storage material (OSM) (509 g) (OSC=10% CeO₂) by using the incipient wetness method. The mixture was then calcined at 550° C. for 2 hours.

Calcined palladium-zirconia on alumina was added to water containing La nitrate solution (140 g, La₂O₃=27%) under mixing at pH about 4.0-4.5. To this barium sulfate (57 g, BaO=65%) was added. pH of the mixture was adjusted to 4.5-5.0 using nitric acid. The mixture was continuously milled using an Eiger mill to particle size distribution at 90% less than 12-14 micro meters.

The two slurries were mixed, and pH was adjusted to about 4.0-4.5 if needed. To this mixture, an alumina binder (50 g @ 20% solid) was added and mixed well. The obtained final mixture which resulted a wash coat loading of about 2.0 g/in³ was dried and calcined at 550° C. for 2 hours.

Overall Wash Coat Loading:

Bottom layer coat: Pd=0.0133 g/in³, oxygen storage material (OSM)=1.0 g/in³, Alumina=0.5 g/in³, zirconia (colloidal)=0.05, BaO=0.1 g/in³, La₂O₃=0.05 g/in³ alumina binder: 0.02 g/in³.

Total bottom wash coat loading: 1.73 g/in³.

Top layer coat: Rh=0.0023 g/in³ (Rh=4 g/ft³), Pd=0.0133 g/in³, alumina=0.75 g/in³, OSM=1.0 g/in³, La₂O₃=0.075 g/in³, BaO=0.075 g/in³, zirconia=0.075, alumina binder: 0.02 g/in³.

Total top wash coat loading: 2.0 g/in³.

Two wash coated catalysts (reference catalyst, RC-2 and invention catalyst, IC-2) on cordierite substrates designed with layering structure are shown in FIG. 1B. The top and bottom layer of the reference catalyst (RC-2) contained Pd on alumina, whereas the invention catalyst (IC-2) contained palladium with colloidal zirconia on alumina in both top and bottom layer.

Comparative Testing of Reference Catalyst (RC-2) and Invention Catalyst (IC-2):

The as-prepared full part washcoated catalysts (Pd/Rh=46/4 g/ft³; 4.16″×3.0″, 600/4) were aged on engine at 950° C. for 75 hours, and then tested as CC-1 catalysts on a vehicle for FTP-75 cycles. The CC-2 catalyst was kept the same for all testing, which was a simple Pd bottom coat and Rh top coat catalyst with Pd:Rh loading of 14/4 g/ft³.

FIG. 2B shows the FTP-75 test results on a vehicle for reference catalyst (RC-2 and invention catalyst (IC-2) for cumulative mid-bed and tail-pipe HC and NOx emission. It was found that ZrO₂ sol material as a Pd promoter significantly decreased the mid-bed HC emission by 39%. From the analysis of tail-pipe HC emission, it was found that there is 21% decrease in HC cumulative emission. Similar to Example 2, much larger difference was observed in NOx emission. Comparing to reference catalyst 2, the invention catalyst 2 containing ZrO₂ sol—showed a 66% decrease in NOx emission for mid-bed. Further, the NOx reduction in tail-pipe was found to be decreased by 31%.

### Example 5: Preparation of a Layered Three-Way Catalyst (Reference Catalyst-3, RC-3, Bottom Layer: Pd—Al and Top Layer: Rh—Al)

A. Bottom Layer (First Layer) Preparation:

Palladium nitrate solution (30.5 g with Pd concentration=27.6%) was impregnated onto an alumina stabilized with 4.0% La oxide (La doped alumina=454 grams) by using an incipient wetness method. The mixture was then calcined at 550° C. for 2 hours.

Separately, palladium nitrate (20.4 grams) was impregnated onto an oxygen storage material (OSM) (652 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium on alumina was added to water under mixing. To this, barium acetate (247 g, BaO=60%), Zirconyl nitrate 122 g (ZrO₂=20%) and 65 grams of La nitrate solution (La₂O₃=26%) were added to obtain a slurry mixture. The pH of the mixture was adjusted to 4.5-5.0 using nitric acid. The mixture was continuously milled using an Eiger mill to particle size distribution at 90% less than 20 micro meters. To this, calcined Pd on OSM was added and pH was adjusted to 4.5 to 5.0 using nitric acid and milled to particle size distribution (PSD) at 90% less than 14 micrometers.

Finally, alumina binder (9.6 grams) was added to the mixture and mixed well. The obtained final mixture which resulted a wash coat loading of about 2.6 g/in³ was dried and calcined at 550° C. for 2 hours.

B. Top Layer (Second Layer) Preparation:

Rhodium nitrate solution (27.4 g with Rh concentration=10.2%) was impregnated onto an alumina stabilized with 4.0% La oxide (La doped alumina=1041 grams) by using an incipient wetness method. The impregnated Rh on alumina was added onto water containing 245 grams of dispersed oxygen storage material dispersed in water (The oxygen storage material, CeO₂—ZrO₂ with 50% CeO₂ and 50% ZrO₂ and solid of about 70%). The pH of the slurry was kept at about 4.5 and the slurry milled to particle size distribution at 90% less than 14 micrometers.

Finally, alumina binder (9.6 grams) was added to the mixture and mixed well. The obtained final mixture which resulted a wash coat loading of about 2.6 g/in³ was dried and calcined at 550° C. for 2 hours.

Overall Wash Coat Loading:
Bottom layer coat: Pd=0.0266 g/in³, oxygen storage material (OSM)=1.3 g/in³, Alumina=0.9 g/in³, ZrO₂=0.05 g/in³, BaO=0.3 g/in³, alumina binder=0.02 g/in³.
Total bottom wash coat loading=2.6 g/in³.
Top layer coat: Rh=0.0023 g/in³ (Rh=4 g/ft³), alumina=0.85 g/in³, Ce—ZrO₂=0.15 g/in³, alumina binder: 0.02 g/in³.
Total top wash coat loading: 1.02 g/in³.

### Example 6: Preparation of a Layered Three-Way Catalyst (Invention Catalyst-3, IC-3, Bottom Layer: Pd-Colloidal Zirconia-Al and Top Layer: Rh—Al)

A. Bottom Layer (First Layer) Preparation:

A mixture of 29.7 g Pd nitrate and 179 g of colloidal Zirconia (20% ZrO₂, average particle size: ≤5.0-20 nm) was impregnated onto an alumina stabilized with 4.0% La oxide (La doped alumina=441 grams) by using an incipient wetness method. The mixture was then calcined at 550° C. for 2 hours.

Separately, palladium nitrate (19.8 grams) was impregnated onto an oxygen storage material (OSM) (634 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium-Zirconia on alumina was added to water under mixing. To this, barium acetate (240 g, BaO=60%), Zirconyl nitrate 119.5 g (ZrO₂=20%) and 63 grams of La nitrate solution (La₂O₃=26%) were added to obtain a slurry mixture. The pH of the mixture was adjusted to 4.5-5.0 using nitric acid. The mixture was continuously milled using an Eiger mill to particle size distribution at 90% less than 20 micro meters. To this, calcined Pd on OSM was added and pH was adjusted to 4.5 to 5.0 using nitric acid and milled to particle size distribution (PSD) at 90% less than 14 micrometers.

Finally, alumina binder (9.6 grams) was added to the mixture and mixed well. The obtained final mixture which resulted a wash coat loading of about 2.7 g/in³ was dried and calcined at 550° C. for 2 hours.

B. Top Layer (Second Layer) Preparation:

Rhodium nitrate solution (27.4 g with Rh concentration=10.2%) was impregnated onto an alumina stabilized with 4.0% La oxide (La doped alumina=1041 grams) by using an incipient wetness method. The impregnated Rh on alumina was added onto water containing 245 grams of dispersed oxygen storage material dispersed in water (The oxygen storage material, CeO₂—ZrO₂ with 50% CeO2 and 50% ZrO₂ and solid of about 70%). The pH of the slurry was kept at about 4.5 and the slurry milled to particle size distribution at 90% less than 14 micrometers.

Finally, alumina binder (48.5 grams) was added to the mixture and mixed well. The obtained final mixture which resulted a wash coat loading of about 2.6 g/in³ was dried and calcined at 550° C. for 2 hours.

Overall Wash Coat Loading:
Bottom layer coat: Pd=0.0266 g/in³, oxygen storage material (OSM)=1.3 g/in³, Alumina=0.9 g/in³, colloidal ZrO₂=0.125 g/in³, BaO=0.3 g/in³, La₂O₃=0.035 g/in³, alumina binder=0.02 g/in³.
Total bottom wash coat loading: 2.7 g/in³.
Top layer coat: Rh=0.0023 g/in³ (Rh=4 g/ft³), alumina=0.85 g/in³, Ce—ZrO₂=0.15 g/in³, alumina binder=0.02 g/in³.
Total top wash coat loading: 1.02 g/in³.

### Example 7: Preparation of a Layered Three-Way Catalyst (Catalyst-4, C-4, Bottom Layer: Pd-Colloidal Zirconia (100 nm)-Al and Top Layer: Rh—Al)

A. Bottom Layer (First Layer) Preparation:

A mixture of 52.5 g Pd nitrate and 313 g of colloidal Zirconia (20% ZrO₂, average particle size: 100 nm) was impregnated onto alumina stabilized with 4.0% La oxide (La doped alumina=780 grams) by using an incipient wetness method. The mixture was then calcined at 550° C. for 2 hours.

Separately, palladium nitrate (35 grams) was impregnated onto an oxygen storage material (OSM) (1122 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium-Zirconia on alumina was added to water under mixing. To this, barium acetate (425 g, BaO=60%), Zirconyl nitrate 211.4 g (ZrO₂=20%) and 112 grams of La nitrate solution (La₂O₃=26%) were added to obtain a slurry mixture. The pH of the mixture was adjusted to 4.5-5.0 using nitric acid. The mixture was continuously milled using an Eiger mill to particle size distribution at 90% less than 20 micro meters. To this, calcined Pd on OSM was added and pH was adjusted to 4.5 to 5.0 using nitric acid and milled to particle size distribution (PSD) at 90% less than 14 micrometers.

Finally, alumina binder (85.8 grams) was added to the mixture and mixed well. The obtained final mixture which resulted a wash coat loading of about 2.7 g/in³ was dried and calcined at 550° C. for 2 hours.

B. Top Layer (Second Layer) Preparation:

Rhodium nitrate solution (27.4 g with Rh concentration=10.2%) was impregnated onto alumina stabilized with 4.0% La oxide (La doped alumina=1041 grams) by using an incipient wetness method. The impregnated Rh on alumina was added into water containing 245 grams of dispersed oxygen storage material dispersed in water (The oxygen storage material, CeO₂—ZrO₂ with 50% CeO₂ and 50% ZrO₂ and solid of about 70%). The pH of the slurry was kept at about 4.5 and the slurry milled to particle size distribution at 90% less than 14 micrometers.

Finally, alumina binder (9.6 grams) was added to the mixture and mixed well. The obtained final mixture which resulted a wash coat loading of about 2.6 g/in³ was dried and calcined at 550° C. for 2 hours.

Overall Wash Coat Loading:

Bottom layer coat: Pd=0.0266 g/in³, oxygen storage material (OSM)=1.3 g/in³, Alumina=0.9 g/in³, ZrO₂=0.125 g/in³, BaO=0.3 g/in³, La₂O₃=0.035 g/in³, alumina binder=0.02 g/in³.

Total bottom wash coat loading=2.7 g/in³.

Top layer coat: Rh=0.0023 g/in³ (Rh=4 g/ft³), alumina=0.85 g/in³, Ce—ZrO₂=0.15 g/in³, alumina binder=0.02 g/in³.

Total top wash coat loading: 1.02 g/in³.

Three washcoated catalysts (Reference catalyst, RC-3, invention catalyst, IC-3 and catalyst-4, C-4) on cordierite substrates were designed with layering structure to check effect of particle size of colloidal zirconia. The designs are shown in FIG. 1C.

The top layer of these catalysts containing rhodium was kept same, whereas the bottom layers of the catalyst containing palladium were modified. The bottom layer of the reference catalyst (RC-3) contained Pd on alumina and Pd on ceria-zirconia. The bottom layer of the invention catalyst (IC-3) contained Pd on colloidal zirconia having particle size in the range of 5.0 to 10 nm supported on an alumina, and Pd on ceria-zirconia. The bottom layer of the catalyst-4 (C-4) was similar to the bottom layer of the invention catalyst (IC-3) except that the particle size of colloidal zirconia on which Pd is deposited is 100 nm.

Comparative testing of Reference catalyst (RC-3), invention catalyst (IC-3) and catalyst-4 (C-4):

The as-prepared full part washcoated catalysts (Pd/Rh=46/4 g/ft³; 4.16″×3.0″, 600/4) were aged on engine at 950° C. for 75 hours, and then tested as CC-1 catalysts on a vehicle for FTP-75 cycles. The CC-2 catalyst was kept the same for all testing, which was a simple Pd bottom coat and Rh top coat catalyst with Pd:Rh loading of 14/4. FIG. 2C shows the FTP-75 test results on a vehicle for reference catalyst (RC-3), invention catalyst (IC-3) and catalyst-4 (C-4) for cumulative mid-bed HC and NOx emission. It is found that, using the colloidal ZrO₂ sol material with smaller particle size (5-10 nm) as a Pd promoter in the invention catalyst (IC-3) decreased the mid-bed HC emission, while using the colloidal ZrO₂ sol material with larger particle size (100 nm) for Pd in catalyst (C-4) increased the mid-bed HC emission comparing to reference catalyst (RC-3). This totally opposite effects of the small size and large size colloidal ZrO₂ sol on Pd for TWC performance is also observed in NOx emission. Comparing to reference catalyst (RC-3), the invention catalyst (IC-3) containing ZrO₂ sol with small particle size as Pd promoter showed a decrease in NOx emission for mid-bed by 16%. In contrast, the catalyst (C-4) containing ZrO₂ sol with large particle size as a Pd promoter showed an increase in NOx emission for mid-bed by 32%, indicating that the larger size of colloidal ZrO₂ sol exhibits deactivation effect for TWC performance.

### Example 8: Preparation of a Layered Three-Way Catalyst (Invention Catalyst-5, IC-5, Bottom Layer: Pd/Pt-Colloidal Zirconia and Top Layer: Pt—Al/Rh—OSC)

A. Bottom Layer Preparation:

A mixture of 32.5 g of Pd nitrate and 213 g of colloidal zirconia (ZrO₂ level of 20%, average particle size in the range of 5.0-10 nm) was impregnated onto an alumina stabilized with 4% La oxide (La doped alumina=663 grams) by using an incipient wetness method. The mixture was then calcined at 550° C. for 2 hours.

Separately, palladium nitrate (32.5 grams) was impregnated onto an oxygen storage material (OSM) (1105 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium-Zirconia on alumina was added to water solution containing 73.9 grams of Pt tetra ammine hydroxide (Pt=18%). To the obtained slurry, 289 g of barium acetate (BaO=60%), zirconium acetate (30% ZrO₂) and 299 g of barium acetate (60% BaO) were added under mixing. The pH of the mixture was adjusted to 4.5-5 using nitric acid. The mixture was continuously milled to particle size distribution at 90% less than 12-14 micro meters.

Separately, Pd supported on OSC was added to water. The pH was adjusted to about 4.5 followed by milling to particle size distribution at 90% less than 12-14 micro meters.

The two slurries were mixed, and pH was adjusted to 4.5 to 5.0 using nitric acid. Alumina binder (109 grams) was added to the mixture and mixed well. The obtained final mixture was coated onto ceramic substrates which resulted in a wash coat loading of about 2.3 g/in³ was dried and calcined at 550° C. for 2 hours.

A. Top Layer Preparation:

A 30.8 g of Pt tetraammine hydroxide solution (Pt=16%) was impregnated onto an alumina stabilized with 4% La oxide (La doped alumina=429 grams) by using an incipient wetness method. The mixture was then added into a Pd nitrate solution (Pd nitrate solution 13.2 g at Pd=38%). The mixture was mixed well and to this barium sulfate was added followed by milling to a particle size of 90% 12-14 micrometers.

Separately, 19.65 g of Rh nitrate solution was impregnated onto 644 grams of oxygen storage material containing 10% CeO₂. Rh was precipitated onto the support and milled to particle size distribution at 90% less than 12 micrometer.

The two slurries were mixed, and pH was adjusted to 4.5 to 5.0 using nitric acid. To this an alumina binder was added. The obtained final slurry was coated onto a ceramic substrate which resulted in a wash coat loading of about 1.3 g/in³, followed by drying and calcination at 550° C. for 2 hours.

Overall Wash Coat Loading:

Bottom layer coat: Pt=0.0154 g/in³, Pd=0.0176 g/in³, oxygen storage material (OSM)=1.25 g/in³, Alumina=0.75 g/in³, colloidal ZrO₂=0.05 g/in³, BaO=0.2 g/in³, alumina binder=0.025 g/in³.

Total bottom wash coat loading=2.3 g/in³.

Top layer coat: Pt=0.0066 g/in³, Rh=0.0023 g/in³ (Rh=4 g/ft³), Pd=0.0044 g/in³, Alumina=0.5 g/in³, Ce—ZrO₂=0.75 g/in³, alumina binder=0.025 g/in³.

Total top wash coat loading=1.3 g/in³.

### Example 9: Preparation of a Layered Three-Way Catalyst (Invention Catalyst-6, IC-6)

Bottom layer: Pd/Pt-colloidal zirconia and Top layer: Pd/Pt-colloidal zirconia & Rh—OSC A mixture of 32.5 g of Pd nitrate and 213 g of colloidal zirconia (20% ZrO₂, average particle size: ≤5.0-20 nm) was impregnated onto an alumina stabilized with 4.0% La oxide (La doped alumina=663 grams) by using an incipient wetness method. The mixture was then calcined at 550° C. for 2 hours.

Separately, palladium nitrate (32.5 grams) was impregnated onto an oxygen storage material (OSM) (1105 grams: OSM: Ce=40%, Zr=60%, La 5.0%, Y=5.0% as oxides) by using the incipient wetness method. The mixture was then calcined at 550° C. for 2 hours.

Slurry Preparation:

Calcined palladium-zirconia on alumina was added to water solution containing 73.9 grams of Pt tetra ammine hydroxide (Pt=18%). To the obtained slurry, 289 grams of barium acetate (BaO=60%) was added followed by addition of zirconium acetate (30% ZrO₂) and 299 g of barium acetate (60% BaO) under mixing. The pH of the mixture was adjusted to 4.5-5.0 using nitric acid. The mixture was continuously milled to particle size distribution at 90% less than 12-14 micro meters.

Separately, Pd supported on OSC was added to water. The pH was adjusted to about 4.5 followed by milling to particle size distribution at 90% less than 12-14 micro meters.

The two slurries were mixed, and pH was adjusted to 4.5 to 5.0 using nitric acid. To this mixture, an alumina binder (109 grams, 20% solid) was added and mixed well. The obtained final mixture was coated onto a ceramic substrate which resulted in a wash coat loading of about 2.3 g/in³ followed by drying and calcination at 550° C. for 2 hours.

B. Top Layer Preparation:

A mixture of 12.87 g Pd nitrate ad 121.6 g of colloidal ZrO₂ was impregnated onto an alumina stabilized with 4.0% La oxide (La doped alumina=419 grams) by using an incipient wetness method. The slurry was then added into a water solution containing 30 g of Pt tetraammine hydroxide (Pt=18%) followed by mixing well and milling to a particle size of 90% 12-14 micrometers.

Separately, 19.2 g of Rh nitrate solution was impregnated onto 629 grams of oxygen storage material containing 10% CeO₂—Rh was precipitated onto support followed by making a slurry and adjusting pH to about 4.5. To this, 25.3 g barium sulfate was added and milled to particle size distribution at 90% less than 12 micrometer.

The two slurries were mixed, and pH was adjusted to 4.5 to 5 using nitric acid. To this, alumina binder (98 grams, 20% solid) was added and mixed well. The obtained final mixture was coated onto a ceramic substrate which resulted in a wash coat loading of about 1.34 g/in³ followed by drying and calcination at 550° C. for 2 hours.

Overall Wash Coat Loading:
Bottom layer coat: Pt=0.0154 g/in³, Pd=0.0176 g/in³, oxygen storage material (OSM)=1.25 g/in³, alumina=0.75 g/in³, colloidal ZrO₂=0.05 g/in³, BaO=0.2 g/in³, alumina binder=0.025 g/in³.
Total bottom wash coat loading=2.3 g/in³.
Top layer coat: Pt=0.0066 g/in³, Rh=0.0023 g/in³ (Rh=4 g/ft³), Pd=0.0044 g/in³, Alumina=0.5 g/in³, Ce—ZrO₂=0.75 g/in³, colloidal zirconia=0.03 g/in³, alumina binder=0.025 g/in³.
Total top wash coat loading: 1.3 g/in³.

Two washcoated catalysts (Invention catalyst IC-5 and invention catalyst-IC-6) on cordierite substrates were designed with layering structure. The designs are shown in FIG. 1D.

The bottom coat of both IC-5 and IC-6 was kept same which contained Pd with colloidal ZrO₂ on an Al₂O₃ based support and Pt. The top coats were varied. The top coat of IC-5 catalyst contained Pt on alumina, Pd, and Rh on OSC, whereas the top coat of IC-6 catalyst contained Pd with colloidal ZrO₂ on an Al₂O₃, Pt, and Rh on OSC.

The as-prepared full part washcoated catalysts were aged on engine at 950° C. for 75 hours, and then tested as CC-1 catalysts on a vehicle for FTP-75 cycles. The CC-2 catalyst was kept the same for all testing, which was a simple Pd bottom coat and Rh top coat catalyst with Pd:Rh loading of 14/4 g/ft³.

Reference throughout this specification to “one embodiment,” “certain embodiments,” “one or more embodiments” or “an embodiment” means that a particular feature, structure, material, or characteristic described in connection with the embodiment is included in at least one embodiment of the presently claimed invention. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the presently claimed invention. Furthermore, the particular features, structures, materials, or characteristics may be combined in any suitable manner in one or more embodiments. All of the various embodiments, aspects, and options disclosed herein can be combined in all variations, regardless of whether such features or elements are expressly combined in a specific embodiment description herein. This presently claimed invention is intended to be read holistically such that any separable features or elements of the disclosed invention, in any of its various aspects and embodiments, should be viewed as intended to be combinable unless the context clearly dictates otherwise.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

1-31. (canceled)

32. An automotive catalyst comprising
i) a platinum group metal chosen from palladium, platinum, rhodium, and any combination thereof in an amount ranging from 1.0 wt. % to 10 wt. %, based on the total weight of the catalyst,
ii) metal oxide nanoparticles in an amount ranging from 1.0 wt. % to 20 wt. %, based on the total weight of the catalyst, and
iii) an alumina component,
wherein the weight ratio of the metal oxide nanoparticles to the alumina component ranges from 1:1.5 to 1:10,
wherein the metal oxide nanoparticles have a D90 diameter ranging from 1.0 nm to 50 nm, measured by Transmission Electron Microscopy,
wherein the platinum group metal and the metal oxide nanoparticles are homogeneously dispersed on the alumina component determined by Transmission Electron Microscopy analysis or Energy-Dispersive x-ray Spectroscopy analysis.

33. The catalyst according to claim 32, wherein the nanoparticles have a D90 diameter ranging from 5.0 nm to 20 nm, measured by Transmission Electron Microscopy.

34. The catalyst according claim 32, wherein the amount of metal oxide nanoparticles ranges from 3.0 wt. % to 15 wt. %, based on the total weight of the catalyst.

35. The catalyst according to claim 32, wherein the platinum group metal(s) is in intimate contact with the metal oxide nanoparticles.

36. The catalyst according to claim 32, wherein the metal oxide nanoparticles are chosen from zirconia nanoparticles, ceria nanoparticles, alumina nanoparticles, manganese nanoparticles, and titania nanoparticles.

37. The catalyst according to claim 32, wherein the metal oxide nanoparticles comprise a dopant chosen from lanthana, barium, manganese, yttrium, praseodymium, neodymium, ceria, and strontium, and wherein the amount of the dopant ranges from 1.0 wt. % to 30 wt. %, based on the total weight of the metal oxide.

38. The catalyst according to claim 32, wherein the metal oxide nanoparticles are chosen from lanthana-zirconia nanoparticles, barium-zirconia nanoparticles, yitria-zirconia nanoparticles, and ceria-zirconia nanoparticles.

39. The catalyst according to claim 32, wherein the metal oxide nanoparticles are chosen from lanthana-alumina nanoparticles, ceria-alumina nanoparticles, ceria-zirconia-alumina nanoparticles, zirconia-alumina nanoparticles, lanthana-zirconia-alumina nanoparticles, baria-alumina nanoparticles, baria-lanthana-alumina nanoparticles, baria-lanthana-neodymia-alumina nanoparticles, baria-ceria-alumina nanoparticles, and ceria-zirconia-alumina nanoparticles.

40. The catalyst according to claim 32, wherein the alumina component is an alumina or alumina doped with a dopant, wherein the dopant is chosen from lanthana, ceria, ceria-zirconia, zirconia, lanthana-zirconia, baria, baria-lanthana, baria-lanthana-neodymia, baria-ceria, ceria-zirconia, and any combination thereof, and wherein the amount of the dopant ranges from 5.0 wt. % to 30 wt. %, based on the total weight of alumina.

41. The catalyst according to claim 32, wherein the alumina component is an alumina or alumina doped with a dopant, with a surface area greater than 20 m²/g and average pore volume greater than 0.2 cc/g.

42. The catalyst according to claim 32, wherein the catalyst comprises:
a) palladium in an amount ranging from 1.0 wt. % to 10 wt. %, based on the total weight of the catalyst,
b) zirconia nanoparticles in an amount ranging from 3.0 wt. % to 15 wt. %, based on the total weight of the catalyst, and
c) an alumina component,
wherein the weight ratio of the metal oxide nanoparticles to the alumina component ranges from 1:1.5 to 1:7,
wherein palladium and the zirconia nanoparticles are homogeneously dispersed on the alumina component,
wherein palladium is in intimate contact with the zirconia nanoparticles,
wherein the zirconia nanoparticles have a D90 diameter ranging from 1.0 nm to 50 nm.

43. The catalyst according to claim 32, wherein the catalyst comprises:
a) Palladium in an amount ranging from 1.0 wt. % to 10 wt. %, based on the total weight of the catalyst,
b) Platinum in an amount ranging from 1.0 wt. % to 10 wt. %, based on the total weight of the catalyst,
c) zirconia nanoparticles in an amount ranging from 3.0 wt. % to 15 wt. %, based on the total weight of the catalyst, and
d) an alumina component,
wherein the weight ratio of the metal oxide nanoparticles to the alumina component ranges from 1:1.5 to 1:7,
wherein palladium, platinum, and the zirconia nanoparticles are homogeneously dispersed on the alumina component,
wherein palladium and platinum are in intimate contact with the zirconia nanoparticles,
wherein the zirconia nanoparticles have a D90 diameter ranging from 1.0 nm to 50 nm.

44. The catalyst according to claim 32, wherein the platinum group metal and the metal oxide nanoparticles or zirconia nanoparticles dispersed on the alumina component are thermally or chemically fixed.

45. A layered automotive catalytic article comprising the catalyst according to claim 32, deposited on a substrate as a top layer, bottom layer or both, optionally along with at least one second platinum group metal, wherein the substrate is chosen from a flow through or wall flow metallic substrate, and a flow through or wall flow ceramic substrate.

46. The catalytic article according to claim 45, wherein the amount of palladium loading ranges from 0.005 g/in³ to 0.15 g/in³, the amount of rhodium loading ranges from 0.001 g/in³ to 0.02 g/in³, the amount of platinum loading ranges from 0.005 g/in³ to 0.15 g/in³, the amount of metal oxide nanoparticles loading ranges from 0.005 g/in³ to 0.25 g/in³, and the amount of alumina component loading ranges from 0.5 g/in³ to 3 g/in³.

47. The catalytic article according to claim 32, wherein the bottom layer, top layer, or both comprise at least one alkaline earth metal oxide comprising barium oxide, strontium oxide, lanthanum oxide, or any combination thereof, in an amount ranging from 1.0 wt. % to 20 wt. %, based on the total weight of the top or bottom layer.

48. The catalytic article according to claim 45, wherein the catalytic article comprises:
a) a bottom layer comprising the catalyst;
b) a top layer comprising at least one platinum group metal comprising palladium, platinum, rhodium, or any mixture thereof, and at least one support chosen from an alumina, an oxygen storage component, and a zirconia component; and
c) a substrate.

49. The catalytic article according to claim 45, wherein the catalytic article comprises:
a) a bottom layer comprising the catalyst,
b) a top layer comprising rhodium supported on an oxygen storage component, an alumina component, or both; and
c) a substrate.

50. The catalytic article according to claim 45, wherein the catalytic article comprises:
a) a bottom layer comprising:
i. the catalyst,
ii. palladium supported on an oxygen storage component, and
iii. barium oxide, lanthanum oxide, or both;
b) a top layer comprising:
i. rhodium supported on an oxygen storage component, and
ii. rhodium supported on an alumina component; and
c) a substrate.

51. The catalytic article according to claim 45, wherein the catalytic article comprises:
a) a bottom layer comprising i) the catalyst, ii) palladium supported on an oxygen storage component, and iii) barium oxide;
b) a top layer comprising i) rhodium supported on an oxygen storage component and/or an alumina component, and ii) the catalyst; and
c) a substrate.

52. The catalytic article according to claim 45, wherein the catalytic article comprises:
a) a bottom layer comprising i) the catalyst, ii) palladium supported on an oxygen storage component, iii) barium oxide, and iv) lanthanum oxide, b) a top layer comprising:
i. rhodium and palladium supported on an oxygen storage component, an alumina component, or both;
ii. the catalyst;
iii. barium oxide; and
iv. lanthanum oxide, and
c) a substrate.

53. The catalytic article according to claim 45, wherein the alumina comprises alumina, lanthana-alumina, ceria-alumina, ceria-zirconia-alumina, zirconia-alumina, lanthana-zirconia-alumina, baria-alumina, baria-lanthana-alumina, baria-lanthana-neodymia-alumina, or any combination thereof,
wherein the zirconia component comprises zirconia, lanthana-zirconia, barium-zirconia, or ceria-zirconia, and
wherein the oxygen storage component comprises ceria-zirconia, ceria-zirconia-lanthana, ceria-zirconia-yttrium, ceria-zirconia-lanthana-yttrium, ceria-zirconia-neodymium, ceria-zirconia-praseodymium, ceria-zirconia-lanthana-neodymium, ceria-zirconia-lanthana-praseodymium, ceria-zirconia-lanthana-neodymium-praseodymium, or any combination thereof.

54. A process for the preparation of the automotive catalyst according to claim 32, the process comprising: i) dispersing at least one platinum group metal chosen from palladium, platinum and rhodium into colloidal metal oxide nanoparticles having D90 diameter ranging from 1.0 nm to 50 nm to obtain a mixture; and ii) co-impregnating the mixture on an alumina component to obtain a catalyst,
wherein the platinum group metal and the metal or metal oxide nanoparticles are homogeneously dispersed on the alumina component, and the platinum group metal(s) is in intimate contact with the metal oxide nanoparticles.

55. The process according to claim 54, further comprising a step of thermal or chemical fixing of the platinum group metal and/or the metal or metal oxide nanoparticles on the alumina component.

56. A process for the preparation of a layered automotive catalytic article according to claim 45, wherein the process comprises preparing a bottom layer slurry; depositing the bottom layer slurry on a substrate to obtain a bottom layer; preparing a top layer slurry; and depositing the top layer slurry on the bottom layer to obtain a top layer followed by calcination at a temperature in the range from 400° C. to 7000° C.

57. The process according to claim 54, further comprising a step of calcinating before depositing the top layer on the bottom layer, wherein the calcination is carried out at a temperature ranging from 400° C. to 7000° C.

58. A method of treating a gaseous exhaust stream comprising hydrocarbons, carbon monoxide, and nitrogen oxide, the method comprising contacting the exhaust stream with the catalyst according to claim 32.

59. A method of reducing hydrocarbons, carbon monoxide, and nitrogen oxide levels in a gaseous exhaust stream comprising contacting the gaseous exhaust stream with a catalyst according to claim 32 to reduce the levels of hydrocarbons, carbon monoxide, and nitrogen oxide in the exhaust gas.

60. A method for purifying a gaseous exhaust stream comprising hydrocarbons, carbon monoxide, and nitrogen oxide comprising contacting the catalyst according to claim 32.

61. A method for purifying a gaseous exhaust stream comprising hydrocarbons, carbon monoxide, and nitrogen oxide comprising contacting the layered catalytic article according to claim 45.

62. An exhaust system for internal combustion engines comprising the catalytic article according to claim 45 disposed downstream or upstream from an internal combustion engine.
